(19) United States
(12) Patent Application Publication
(10) Pub. No.: US 2022/0097350 A1
(43) Pub. Date: Mar. 31, 2022

(54) LAMINATION KIT

(71) Applicant: Hewlett-Packard Development Company, L.P., Spring, TX (US)

(72) Inventors: George Sarkisian, San Diego, CA (US); Gregg A. Lane, San Diego, CA (US); Sophia Chau, San Diego, CA (US)

(73) Assignee: Hewlett-Packard Development Company, L.P., Spring, TX (US)

(21) Appl. No.: 17/417,430

(22) PCT Filed: Feb. 8, 2019
(86) PCT No.: PCT/US2019/017259

§ 371 Date: Jun. 23, 2021

(51) Int. Cl. B32B 27/08; C08K 5/56; C08L 33/08; C09D 11/54; C09D 11/322; C09D 11/107; C09D 11/102; B32B 37/12; B41M 5/50; B32B 38/00; B41M 5/00

(52) U.S. Cl. CPC B32B 27/08; B32B 2309/04; C08L 33/08; C09D 11/54; C09D 11/322; C09D 11/107; C09D 11/102; B32B 37/12; B41M 5/502; B32B 38/145; B32B 38/164; B41M 5/0047; B41M 5/0017; B41M 5/0064; B32B 2309/022; B32B 2309/12; B32B 2309/025; C08K 5/56

(57) ABSTRACT

An example of a lamination kit includes a first flexible film substrate, a primer fluid, a fixer fluid, an aqueous inkjet ink, a lamination adhesive, and a second flexible film substrate. The primer fluid includes a first binder. The fixer fluid includes a cationic salt and an organic acid. The aqueous inkjet ink includes a second binder, a pigment, a surfactant, a co-solvent, and a balance of water.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. The technology has become a popular way of recording images on various media surfaces (e.g., paper), for a number of reasons, including, low printer noise, capability of high-speed recording and multi-color recording.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example of a lamination method disclosed herein,

FIG. 2 is a schematic diagram of an example of a laminating system; and

FIG. 3 is a schematic, cross-sectional view of an example of a laminated article disclosed herein.

### DETAILED DESCRIPTION

The creation of flexible packaging by printing on flexible film substrates and then laminating the printed flexible film substrates is a major industry. Flexible film substrates printed on by offset inks or flexographic inks have been used to produce laminated article with acceptable durability (e.g., lamination bond strength, etc.). However, offset and flexographic systems may be costly to set up, and such a cost may not be worthwhile unless thousands of copies are to be printed. In contrast, inkjet printing does not involve costly system setup. In inkjet printing, inks can be printed at high speed in a single pass and with minimal heat for drying. However, using flexible film substrates printed on by inkjet inks to produce laminated articles can present challenges, in part because the lamination process (e.g., the lamination adhesive, etc.) should be compatible with the inks and other fluids (e.g., a primer fluid and/or a fixer fluid) used to create the printed flexible film substrates. When the lamination process is not compatible with the inks and other fluids used to create the printed flexible film substrates, the resulting laminated articles may have poor durability.

Disclosed herein is a lamination kit that includes a primer fluid, a fixer fluid, and an aqueous inkjet ink that are compatible with lamination. More specifically, an example of the lamination kit comprises: a first flexible film substrate; a primer fluid including a first binder; a fixer fluid, including: a cationic salt; and an organic acid; an aqueous inkjet ink, including: a second binder; a pigment; a surfactant; a co-solvent; and a balance of water; a lamination adhesive; and a second flexible film substrate. The first flexible film substrate, the primer fluid, the fixer fluid, and the aqueous inkjet ink may be used to form a printed film, and the lamination adhesive and the second flexible film substrate may be used to laminate the printed film. It has been found that the components of the lamination kit are compatible with lamination. As used herein, “compatible with lamination” means that the component(s), when used in a lamination process, result in a laminated article with acceptable durability. A laminated article may be considered to have acceptable durability when the laminated article has a lamination bond strength greater than about 3.5 N/in. As such, the lamination kit disclosed herein may be used to create flexible packaging.

The aqueous inkjet ink and other fluids of the lamination kit may include different components with different acid numbers. As used herein, the term “acid number” refers to the mass of potassium hydroxide (KOH) in milligrams that is used to neutralize one (1) gram of a particular substance. The test for determining the acid number of a particular substance may vary, depending on the substance. For example, to determine the acid number of a polyurethane-based binder, a known amount of a sample of the binder may be dispersed in water and the aqueous dispersion may be titrated with a polyelectrolyte titrant of a known concentration. In this example, a current detector for colloidal charge measurement may be used. An example of a current detector is the MOtek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). For another example, to determine the acid number of a styrene-acrylic binder, a known amount of a sample of the binder may be dissolved in an organic solvent and the solution may be titrated with a solution of potassium hydroxide of a known concentration. Two titration categories can be used, namely potentiometric or colorimetric. The potentiometric method uses a potentiometer to detect the acidic constituents and coverts it to an electronic read out. The output is plotted and analyzed to determine the inflection of the test method. The colorimetric method uses paranaphthol-benzene, which responds to a change in the pH indicator that has been added to the solution. Once the acidic constituents have been neutralized by the KOH, the sample will change from orange to blue-green, indicating the end point. An example of a suitable standard test method is ASTM D3642-15, which is a standard test method for acid number of certain alkali-soluble resins from ASTM (American Society for Testing Materials) International. It is to be understood that any suitable test for a particular component may be used.

Throughout this disclosure, a weight percentage that is referred to as “wt % active” refers to the loading of an active component of a dispersion or other formulation that is present in the primer fluid, the fixer fluid, the aqueous inkjet ink, or lamination adhesive. For example, the second binder may be present in a water-based formulation (e.g., a stock solution or dispersion) before being incorporated into the aqueous inkjet ink. In this example, the wt % actives of the second binder accounts for the loading (as a weight percent) of the second binder that is present in the aqueous inkjet ink, and does not account for the weight of the other components (e.g., water, etc.) that are present in the formulation with the second binder. The term “wt %,” without the term actives, refers to either i) the loading (in the primer fluid, fixer fluid, aqueous inkjet ink, or lamination adhesive) of a 100% active component that does not include other non-active components therein, or the loading (in the primer fluid, fixer fluid, aqueous inkjet ink, or lamination adhesive) of a material or component that is used “as is” and thus the wt % accounts for both active and non-active components.

The various compositions of the lamination kit will now be described.

Flexible Film Substrates

Examples of the lamination kit disclosed herein include a first flexible film substrate and a second flexible film substrate. The first flexible film substrate may have a printed image generated thereon, and the second flexible film substrate may be laminated over the printed image generated on the first flexible film substrate.

The first flexible film substrate and/or the second flexible film substrate may be a low energy, non-porous, non-polar/hydrophobic substrate. The term “low energy” refers to the surface energy of the medium, and may be measured by the contact angle a liquid (such as water) has on the surface. The larger the contact angle, the more hydrophobic the surface. The contact angle and the surface energy may vary depending upon the medium. As examples, the contact angle of water on polyvinyl chloride is about 85.6, and on polypropylene is about 1.2, and on polyethylene is about 96. In some examples of the lamination kit, one or both of the first and second flexible film substrates comprise a material selected from the group consisting of polyethylenes, polyethylene terephthalate, polyvinyl chloride, polystyrenes, and biaxially oriented polypropylene. In other examples of the lamination kit, the first flexible film substrate is selected from the group consisting of a first polyethylene substrate, a polyethylene terephthalate substrate, a polyvinyl chloride substrate, a polystyrene substrate, and a biaxially oriented polypropylene substrate; and the second flexible film substrate is a second polyethylene substrate.

In some examples, the first flexible film substrate and/or the second flexible film substrate may be a polyethylene substrate. In some of these examples, each of the first flexible film substrate and the second flexible film substrate is a polyethylene substrate. In others of these examples, the second flexible film substrate is a polyethylene substrate and the first flexible film substrate may be another material. It may be desirable for the second flexible film substrate to be a polyethylene substrate so that a heat-sealable pouch may be formed with another laminated article. In one example, two laminated articles may be heat sealed together, e.g., at some of the edges, to form a pouch that has the polyethylene substrates of the respective articles facing each other and forming the interior surfaces. However, it is to be understood that a heat-sealable pouch may also be formed from the laminated article when the second flexible film substrate comprises a material other than polyethylene, such as as heat-sealable version of polyethylene terephthalate or biaxially oriented polypropylene. Such a heat-sealable pouch may be desirable for flexible packaging. When the first flexible film substrate and/or the second flexible film substrate is a polyethylene substrate, low density polyethylene or high density polyethylene may be used.

In some examples, the first flexible film substrate and the second flexible film substrate may comprise the same material (e.g., a polyethylene, polyethylene terephthalate, polyvinyl chloride, a polystyrene, or biaxially oriented polypropylene). In other examples, the first flexible film substrate and the second flexible film substrate may comprise different materials. For example, the first flexible film substrate may comprise biaxially oriented polypropylene, and the second flexible film substrate may comprise polyethylene.

In some examples, the first flexible film substrate and/or the second flexible film substrate may be corona treated or plasma treated. In some examples, the first flexible film substrate and/or the second flexible film substrate may be untreated.

In an example, the first flexible film substrate may have a thickness ranging from about 0.1 mm to about 2.0 mm. In another example, the second flexible film substrate may have a thickness ranging from about 0.1 mm to about 2.0 mm. It may be desirable for the first flexible film substrate and/or the second flexible film substrate to have a thickness within these ranges so that: (i) the first flexible film substrate and/or the second flexible film substrate may transported on a conveyer without being distorted; and (ii) the proper tension on a film roll of the first flexible film substrate and/or the second flexible film substrate may be maintained by a printer and/or a laminator. Thicker substrates may take more heat to seal. Thinner substrates may wrinkle and/or deform upon exposure to heat and/or may be more difficult to print on when there are folds in the substrate.

Primer Fluids

Examples of suitable primer fluids that may be used in the lamination kit include a first binder. Examples of the primer fluid disclosed herein may be compatible with lamination.

Examples of the primer fluid disclosed herein may be used in a drawdown coater, slot die coater, roller coater, fountain curtain coater, blade coater, rod coater, air knife coater, or gravure application to prime the first flexible film substrate. The viscosity of the primer fluid may be adjusted for the type coater that is to be used. As an example, the viscosity of the primer fluid may range from about 100 centipoise (cP) to about 300 cP (at 20° C. to 25° C. and about 100 rotations per minute (rpm)).

First Binders

The first binder of the primer fluid may be a combination of a first acrylic binder and zirconium acetate, or a combination of the first acrylic binder and a first polyurethane binder.

In some examples of the lamination kit, the first binder is a combination of an acrylic binder and zirconium acetate. In these examples, the zirconium acetate may act as a crosslinker of the acrylic binder. In some of these examples, the first binder may include the acrylic binder in an amount of about 50 wt % active and the zirconium acetate in an amount of about 50 wt % active, based on the total weight of the first binder. A commercially available example of such a combination of the acrylic binder and zirconium acetate is AQUATACK™ 1422 (a water-based dispersion including 50 wt % active acrylic binder and 50 wt % active zirconium acetate) available from Paramelt.

In other examples of the lamination kit, the first binder is the combination of the first acrylic binder and the first polyurethane binder. In some of these examples, the first acrylic binder is a poly(ethyl acrylate) binder, and the first polyurethane binder is an ethylene acrylic acid and polyurethane binder. As such, in some examples, the first binder is a combination of a poly(ethyl acrylate) binder and an ethylene acrylic acid and polyurethane binder. In some of these examples, the first binder may include the poly(ethyl acrylate) binder in an amount ranging from about 60 wt % to about 80 wt % and the ethylene acrylic acid and polyurethane binder in an amount ranging from about 20 wt % to about 40 wt %, based on the total weight of the first binder. In some other of these examples, the first binder may include the poly(ethyl acrylate) binder in an amount of about 70 wt % and the ethylene acrylic acid and polyurethane binder in an amount of about 30 wt %, based on the total weight of the first binder. An example of a commercially available poly(ethyl acrylate) binder is PRINTRITE™ DP282 (a water-based poly(ethyl acrylate) polymer dispersion) available from Lubrizol. An example of a commercially available ethylene acrylic acid and polyurethane binder is DIGIPRIME® 4431 (a water-based ethylene acrylic acid and polyurethane dispersion) available from Michelman, Inc.

Examples of the primer fluid disclosed herein are to be used with examples of the aqueous inkjet ink disclosed herein in a lamination process. As such, it may be desirable for the combination of the first binder (in the primer fluid) and the binder in the aqueous inkjet ink (referred to as “second binder”) to be compatible with lamination. As such, in some examples of lamination kit, whether the first binder (in the primer fluid) is the combination of the first acrylic binder and zirconium acetate or the combination of the first acrylic binder and the first polyurethane binder may depend, at least in part, on the second binder that is included in the aqueous inkjet ink. As an example, when the second binder in the aqueous inkjet ink is a second acrylic binder, the first binder in the primer fluid may be the combination of the first acrylic binder and zirconium acetate. As another example, when the second binder in the aqueous inkjet ink is a second polyurethane binder, the first binder in the primer fluid may be the combination of the first acrylic binder and the first polyurethane binder.

In some examples of the lamination kit, the first binder is present in the primer fluid in an amount ranging from about 50 wt % active to about 80 wt % active, based on the total weight of the primer fluid. In other examples, the first binder is present in the primer fluid in an amount of about 50 wt % active, based on the total weight of the primer fluid.

Additional Components

In some examples, the primer fluid includes water in addition to the first binder. The water may be added to the first binder or may be part of a dispersion of the first binder. In some examples, the primer fluid includes water in an amount ranging from about 20 wt % to about 50 wt %, based on the total weight of the primer fluid.

In some examples, the primer fluid consists of the first binder and water, with no other components. For example, when first binder includes the combination of the first acrylic binder and zirconium acetate, the primer fluid may consist of the first binder and water, with no other components.

In other examples, the primer fluid may include additional components, such as a fluorosurfactant. For example, when first binder is the combination of the first acrylic binder and the first polyurethane binder; the first acrylic binder is a poly(ethyl acrylate) binder; and the first polyurethane binder is an ethylene acrylic acid and polyurethane binder, the primer fluid may further comprise a fluorosurfactant. In one of these examples, the primer fluid consists of the poly(ethyl acrylate) binder, the ethylene acrylic acid and polyurethane binder, the fluorosurfactant, and water, with no other components.

The fluorosurfactant may be included to improve the wettability of the primer fluid. Examples of the fluorosurfactant include ZONYL® FSN, ZONYL® FSO, ZONYL® FSH, and CAPSTONE® FS-35 (each of which is a water-soluble, ethoxylated non-ionic fluorosurfactant manufactured by E.I. DuPont de Nemours and Company). In some examples, the primer fluid includes the fluorosurfactant in an amount ranging from about 0.2 wt % to about 1.0 wt %, based on the total weight of the primer fluid.

Fixer Fluids

Examples of suitable fixer fluids that may be used in the lamination kit may be compatible with lamination. Examples of the fixer fluid disclosed herein include a cationic salt and an organic acid.

In some examples of the lamination kit, the fixer fluid may also include an aqueous vehicle, which may include, e.g., a surfactant, a co-solvent, and water. In one of these examples, the fixer fluid consists of: the cationic salt; the organic acid; a surfactant; a co-solvent; and a balance of water. In this example, the fixer fluid includes no other components. In another of these examples, the fixer fluid may include additional components, such as a chelating agent, an antimicrobial agent an anti-kogation agent, and/or a pH adjuster. In still another of these examples, the fixer fluid consists of the cationic salt, the organic acid, the surfactant, the co-solvent, water, and an additive selected from the group consisting of a chelating agent, an antimicrobial agent, an anti-kogation agent, a pH adjuster, and combination thereof.

In some examples, the fixer fluid does not include and/or is devoid of any water-insoluble substances. As such, in these examples, the fixer fluid is a clear solution. In some other examples, the fixer fluid does not include and/or is devoid of a binder (e.g., a hydrophilic binder polymer).

As used herein, the term “devoid of”, when referring to a component (such as, e.g., a water-insoluble substance or a binder), may refer to a composition that does not include any added amount of the component, but may contain residual amounts, such as in the form of impurities. The components may be present in trace amounts, and in one aspect, in an amount of less than 0.1 weight percent (wt % or wt % active) based on the total weight of the composition (e.g., the fixer fluid), even though the composition is described as being “devoid of” the component. In other words, “devoid of” a component may mean that the component is not specifically included, but may be present in trace amounts or as an impurity inherently present in certain ingredients.

Examples of the fixer fluid disclosed herein may be used in a thermal inkjet printer or in a piezoelectric printer to pre-treat a primed flexible film substrate. The viscosity of the fixer fluid may be adjusted for the type of printhead that is to be used, and the viscosity may be adjusted by adjusting the co-solvent level and/or adding a viscosity modifier. When used in a thermal inkjet printer, the viscosity of the fixer fluid may be modified to range from about 1 cP to about 9 cP (at 20° C. to 25° C.), and when used in a piezoelectric printer, the viscosity of the fixer fluid may be modified to range from about 2 cP to about 20 cP (at 20° C. to 25° C.), depending on the type of the printhead that is being used (e.g., low viscosity printheads, medium viscosity printheads, or high viscosity printheads).

Cationic Salts

The fixer fluid includes the cationic salt. The cationic salt may be soluble in an aqueous vehicle of the fixer fluid. In some examples, the cationic salt may be a multivalent metal salt, a cationic polymer salt, or a combination thereof.

In some examples, the cationic salt includes the multivalent metal salt. The multivalent metal salt may include a multivalent metal cation and an anion. In an example, the multivalent metal salt includes a multivalent metal cation selected from the group consisting of a calcium cation, a magnesium cation, a zinc cation, an iron cation, an aluminum cation, and combinations thereof; and an anion selected from the group consisting of a chloride anion, an iodide anion, a bromide anion, a nitrate anion, a carboxylate anion, a sulfonate anion, a sulfate anion, and combinations thereof.

When the cationic salt includes the multivalent metal salt, the multivalent metal salt (containing the multivalent metal cation) may be present in any suitable amount. In an example, the multivalent metal salt may be present in an amount ranging from about 2 wt % to about 15 wt %, based on the total weight of the fixer fluid. In further examples, the multivalent metal salt may be present in an amount ranging from about 4 wt % to about 12 wt %; or from about 5 wt % to about 15 wt %; or from about 6 wt % to about 10 wt %, based on the total weight of the fixer fluid.

In some examples, the cationic salt includes the cationic polymer salt. In some of these examples (e.g., when the fixer fluid is to be thermal inkjet printed), the cationic polymer salt has a weight average molecular weight (Mw, g/mol or Daltons) of 100,000 or less. This molecular weight enables the cationic polymer salt to be printed by thermal inkjet printheads. In some examples, the weight average molecular weight of the cationic polymer salt ranges from about 800 to about 40,000. It is expected that a cationic polymer salt with a weight average molecular weight higher than 100,000 can be used for examples of the fixer fluid applied by piezoelectric printheads. As such, in other examples, the cationic polymer salt may have a weight average molecular weight higher than 100,000, such as, for example, up to 600,000.

In some examples, the cationic polymer salt is selected from the group consisting of poly(diallyldimethylammonium chloride); poly(methylene-co-guanidine) anion, wherein the anion is selected from the group consisting of hydrochloride, bromide, nitrate, sulfate, and sulfonates; a polyamine; and poly(dimethylamine-co-epichlorohydrin). Examples of poly(diallyldimethylammonium chloride) are commercially available under the tradename FLOQUAT® (e.g., FLOQUAT® FL 4420 PWG, FLOQUAT® FL 4440 PWG, FLOQUAT® FL 4520 PWG, FLOQUAT® FL 4540 PWG, FLOQUAT® FL 4620 PWG, FLOQUAT® FL 4820 PWG, etc.) form S.P.C.M. SA Company. Examples of the polyamine are also commercially available under the tradename FLOQUAT® (e.g., FLOQUAT® FL 2250 PWG, FLOQUAT® FL 2350 PWG, FLOQUAT® FL 2449 PWG, FLOQUAT® FL 2550 PWG, FLOQUAT® FL 2565 PWG, FLOQUAT® FL 2650 PWG, FLOQUAT® FL 2749 PWG, FLOQUAT® FL 2850 PWG, FLOQUAT® FL 2949 PWG, FLOQUAT® FL 3050 PWG, FLOQUAT® FL 3150 PWG, FLOQUAT® FL 3150 K PWG, FLOQUAT® FL 3240 PWG, FLOQUAT® FL 3249 PWG, etc.) form S.P.C.M. SA Company. In one example, the cationic salt is FLOQUAT® FL 2350 PWG.

When the cationic salt includes the cationic polymer salt, the cationic polymer salt may be present in any suitable amount. In an example, the cationic polymer salt may be present in an amount ranging from about 1 wt % active to about 10 wt % active, based on the total weight of the fixer fluid. In further examples, the cationic polymer salt may be present in an amount ranging from about 4 wt % active to about 8 wt % active; or from about 2 wt % active to about 7 wt % active; or from about 6 wt % active to about 10 wt % active, based on the total weight of the fixer fluid. In still another example, the cationic polymer salt may be present in an amount ranging from about 1 wt % active to about 2 wt % active. In yet another example, the cationic polymer salt may be present in an amount of about 2.45 wt % active, based on the total weight of the fixer fluid.

Organic Acids

The fixer fluid includes the organic acid. The organic acid may be soluble in an aqueous vehicle of the fixer fluid. The organic acid may be a mono-, di-, or polyfunctional organic acid. In some examples of the lamination kit, the organic acid of the fixer fluid is selected from the group consisting of acetic acid, glycolic acid, malonic acid, malic acid, maleic acid, ascorbic acid, succinic acid, glutaric acid, fumaric acid, citric acid, tartaric acid, lactic acid, sulfonic acid, ortho-phosphoric acid, and combinations thereof. In one example, the organic acid is succinic acid.

The organic acid may be present in any suitable amount. In an example, the organic acid may be present in an amount ranging from about 0.5 wt % to about 7 wt %, based on the total weight of the fixer fluid. In another example, the organic acid may be present in an amount of about 0.95 wt %.

Aqueous Vehicles

As mentioned above, the fixer fluid may also include an aqueous vehicle. As used herein, the term “aqueous vehicle” may refer to the liquid fluid in which the cationic salt and organic acid are mixed to form a thermal or a piezoelectric fixer fluid.

In an example of the fixer fluid, the aqueous vehicle includes a surfactant, a co-solvent, and a balance of water.

In some examples, the fixer fluid may include a surfactant. The surfactant may aid in wetting and/or dot gain. As such, the surfactant may be selected from the group consisting of a wetting surfactant, a dot gain surfactant, and a combination thereof. Examples of wetting surfactants (i.e., surfactants that may aid in wetting) include fluorosurfactants, such as ZONYL® FSN, ZONYL® FSO, ZONYL® FSH, and CAPSTONE® FS-35 (each of which is a water-soluble, ethoxylated non-ionic fluorosurfactant manufactured by E.I. DuPont de Nemours and Company). Examples of dot gain surfactants (i.e., surfactants that may aid in dot gain) include ethoxylated alcohols/secondary alcohol ethoxylates, such as those from the TERGITOL® series (e.g., TERGITOL® 15-S-30, TERGITOL® 15-S-9, TERGITOL® 15-S-7), manufactured by The Dow Chemical Co.

Whether used alone or in combination, the total amount of the surfactant(s) may be present in the fixer fluid in an amount ranging from about 0.01 wt % active to about 5 wt % active, based on the total weight of the fixer fluid. In an example, a wetting surfactant is present in the fixer fluid in an amount of about 0.41 wt % active, and a dot gain surfactant is present in the fixer fluid in an amount of about 0.95 wt % active, each of which is based on the total weight of the fixer fluid.

In some examples, the fixer fluid may include a co-solvent. The co-solvent may improve decap. As used herein, “decap” refers to the ability of a printing fluid to readily eject from a printhead upon prolonged exposure to air. For example, decap can refer to the amount of time that a printhead may be left uncapped before the printer nozzle no longer fires properly, potentially because of clogging or plugging, e.g., 5 second decap, 60 second decap, 5 minute decap, 15 minute decap, 1 hour decap, etc.

Examples of suitable co-solvents for the fixer fluid are water soluble or water miscible co-solvents. In some examples, the co-solvent is a low-boiling point solvent. As used herein, the term “low-boiling point solvent” refers to a solvent having a boiling point less than or equal to 250° C. In some examples, the low-boiling point solvent is selected from the group consisting of 1,2-ethanediol; 1,2-propanediol; 1,3-propanediol; 2-methyl-1,3-propanediol; 1,2-butanediol; 1,3-butanediol; 1,4-butanediol; 1,5-pentanediol; 1,2-hexanediol; 2,5-hexanediol; 1,2-heptanediol; 1,2-octanediol; 1,8-octanediol; 2-pyrrolidone; 1-(2-hydroxyethyl)-2-pyrrolidone; diethylene glycol; tripropylene glycol methyl ether; and combinations thereof. In other examples, the low-boiling point solvent is tripropylene glycol methyl ether. In still other examples, the low-boiling point solvent has a boiling point less than 200° C. In one of these examples, the low-boiling point solvent is selected from the group consisting of 1,2-ethanediol; 1,2-propanediol; 2-methyl-1,3-propanediol; 1,2-butanediol; 1,8-octanediol: 1-(2-hydroxyethyl)-2-pyrrolidone; and combinations thereof. In another of these examples, the low-boiling point solvent is 1,2-butanediol.

Whether used alone or in combination, the total amount of the co-solvent(s) may be present in the fixer fluid in an amount ranging from about 4 wt % to about 30 wt %, based on the total weight of the fixer fluid. In one example, the total amount of the co-solvent(s) may be present in the fixer fluid in an amount ranging from about 5 wt % to about 25 wt %, based on the total weight of the fixer fluid. The amounts in this range may be particularly suitable for the composition when it is to be dispensed from a thermal inkjet printhead. In another example, the total amount of the co-solvent(s) may be present in the fixer fluid in an amount ranging from about 10 wt % to about 18 wt %, based on the total weight of the fixer fluid. The co-solvent amount may be increased to increase the viscosity of the fixer fluid for a high viscosity piezoelectric printhead. In still another example, the total amount of the co-solvent(s) may be present in the fixer fluid in an amount of about 20 wt %, based on the total weight of the fixer fluid.

It is to be understood that water is present in addition to the surfactant(s) and co-solvent(s) and makes up a balance of the fixer fluid. As such, the weight percentage of the water present in the fixer fluid will depend, in part, upon the weight percentages of the other components. The water may be purified water or deionized water.

An example of the fixer fluid further comprises an additive selected from the group consisting of a chelating agent, an antimicrobial agent, an anti-kogation agent, a pH adjuster, and combinations thereof.

Some examples of the fixer fluid further include a chelating agent. When included, the chelating agent is present in an amount greater than 0 wt % active and less than or equal to 0.5 wt % active, based on the total weight of the fixer fluid. In an example, the chelating agent is present in an amount ranging from about 0.05 wt % active to about 0.2 wt % active, based on the total weight of the fixer fluid.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Antimicrobial agents are another example of an additive that may be included in the fixer fluid. Antimicrobial agents are also known as biocides and/or fungicides. In an example, the total amount of antimicrobial agent(s) in the fixer fluid ranges from about 0.001 wt % active to about 0.1 wt % active (based on the total weight of the fixer fluid). In another example, the total amount of antimicrobial agent(s) in the fixer fluid ranges from about 0.01 wt % active to about 0.05 wt % active (based on the total weight of the fixer fluid). In still another example, the total amount of antimicrobial agent(s) in the fixer fluid is about 0.044 wt % active (based on the total weight of the fixer fluid).

Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

An anti-kogation agent may also be included in a fixer fluid that is to be thermal inkjet printed. Kogation refers to the deposit of dried printing liquid on a heating element of a thermal inkjet printhead. Anti-kogation agent(s) is/are included to assist in preventing the buildup of kogation. In some examples, the anti-kogation agent may improve the jettability of the fixer fluid. The anti-kogation agent may be present in the fixer fluid in an amount ranging from about 0.1 wt % active to about 1.5 wt % active, based on the total weight of the fixer fluid. In an example, the anti-kogation agent is present in an amount of about 0.5 wt % active, based on the total weight of the fixer fluid.

A pH adjuster may also be included in the fixer fluid. A pH adjuster may be included in the fixer fluid to achieve a desired pH (e.g., 6) and/or to counteract any slight pH increase that may occur over time. In an example, the total amount of pH adjuster(s) in the fixer fluid ranges from greater than 0 wt % to about 0.1 wt % (based on the total weight of the fixer fluid). In another example, the total amount of pH adjuster(s) in the fixer fluid is about 0.03 wt % (based on the total weight of the fixer fluid).

An example of a suitable pH adjuster that may be used in the fixer fluid includes methane sulfonic acid.

Suitable pH ranges for examples of the fixer fluid can be less than pH 7, from pH 5 to less than pH 7, from pH 5.5 to less than pH 7, from pH 5 to pH 6.6, or from pH 5.5 to pH 6.6. In one example, the pH of the fixer fluid is pH 6.

Aqueous Inkjet Inks

Examples of suitable aqueous inkjet ink that may be used in the lamination kit may also be compatible with lamination. The aqueous inkjet ink includes a second binder, a pigment, a surfactant, a co-solvent, and a balance of water.

In some examples, the aqueous inkjet ink may consist of the second binder, the pigment, the surfactant, the co-solvent, and the balance of water with no other components. In other examples, the aqueous inkjet ink may include additional components, such as a chelating agent, an antimicrobial agent, an anti-kogation agent, an anti-decel agent, and/or a pH adjuster. In still other examples, the aqueous inkjet ink may consist of the second binder, the pigment, the surfactant, the co-solvent, water, and an additive selected from the group consisting of a chelating agent, an antimicrobial agent, an anti-kogation agent, an anti-decel agent, a pH adjuster, and combination thereof.

Examples of the aqueous inkjet ink disclosed herein may be used in a thermal inkjet printer or in a piezoelectric printer to print on a primed and pre-treated flexible film substrate. The viscosity of the aqueous inkjet ink may be adjusted for the type of printhead that is to be used, and the viscosity may be adjusted by adjusting the co-solvent level, adjusting the second binder level, and/or adding a viscosity modifier. When used in a thermal inkjet printer, the viscosity of the aqueous inkjet ink may be modified to range from about 1 cP to about 9 cP (at 20° C. to 25° C.), and when used in a piezoelectric printer, the viscosity of the aqueous inkjet ink may be modified to range from about 2 cP to about 20 cP (at 20° C. to 25° C.), depending on the type of the printhead that is being used (e.g., low viscosity printheads, medium viscosity printheads, or high viscosity printheads).

In some examples, the lamination kit disclosed herein includes multiple aqueous inkjet inks. In these examples, each of the aqueous inkjet inks may include an example of the second binder, a pigment, a surfactant, a co-solvent, and a balance of water. However, each of the aqueous inkjet inks may include a different pigment or combination of pigments so that a different color (e.g., cyan, magenta, yellow, black, violet, green, brown, orange, purple, white, etc.) is generated by each of the aqueous inkjet inks. As an example, a combination of two or more aqueous inkjet inks selected from the group consisting of a cyan ink, a magenta ink, a yellow ink, and a black ink may be included in the lamination kit.

In other examples, the lamination kit disclosed herein may include a single aqueous inkjet ink.

Second Binders

The second binder of the aqueous inkjet ink may be a second acrylic binder, a second polyurethane binder, or a combination thereof.

In some examples of the lamination kit, the second binder is the second acrylic binder. The second acrylic binder may be any dispersed polymer prepared from acrylate and/or methacrylate monomers, including an aromatic (meth)acrylate monomer that results in aromatic (meth)acrylate moieties as part of the binder. In an example, the second acrylic binder may be a copolymer of (meth)acrylate and styrene.

In some examples, the binder particles can include a single heteropolymer that is homogenously copolymerized. In another example, a multi-phase polymer can be prepared that includes a first heteropolymer and a second heteropolymer. The two heteropolymers can be physically separated in the binder particles, such as in a core-shell configuration, a two-hemisphere configuration, smaller spheres of one phase distributed in a larger sphere of the other phase, interlocking strands of the two phases, and so on. If a two-phase polymer, the first heteropolymer phase can be polymerized from two or more aliphatic (meth)acrylate ester monomers or two or more aliphatic (meth)acrylamide monomers. The second heteropolymer phase can be polymerized from a cycloaliphatic monomer, such as a cycloaliphatic (meth)acrylate monomer or a cycloaliphatic (meth)acrylamide monomer. The first or second heteropolymer phase can include the aromatic (meth)acrylate monomer, e.g., phenyl, benzyl, naphthyl, etc. In one example, the aromatic (meth)acrylate monomer can be a phenoxylalkyl (meth)acrylate that forms a phenoxylalkyl (meth)acrylate moiety within the polymer, e.g. phenoxylether, phenoxylpropyl, etc. The second heteropolymer phase can have a higher T_{g} than the first heteropolymer phase in one example. The first heteropolymer composition may be considered a soft polymer composition and the second heteropolymers composition may be considered a hard polymer composition. If a two-phase heteropolymer, the first heteropolymer composition can be present in the polymer in an amount ranging from about 15 wt % to about 70 wt % of a total weight of the polymer particle, and the second heteropolymer composition can be present in an amount ranging from about 30 wt % to about 85 wt % of the total weight of the polymer particle. In other examples, the first heteropolymer composition can be present in an amount ranging from about 30 wt % to about 40 wt % of a total weight of the polymer particle, and the second heteropolymer composition can be present in an amount ranging from about 60 wt % to about 70 wt % of the total weight of the polymer particle.

In more general terms, whether there is a single heteropolymer phase, or there are multiple heteropolymer phases, heteropolymer(s) or copolymer(s) can include a number of various types of copolymerized monomers, including aliphatic(meth)acrylate ester monomers, such as linear or branched aliphatic (meth)acrylate monomers, cycloaliphatic (meth)acrylate ester monomers, or aromatic monomers. However, in accordance with the present disclosure, the aromatic monomer(s) selected for use can include an aromatic (meth)acrylate monomer. To be clear, reference to an “aromatic (meth)acrylate” does not include the copolymerization of two different monomers copolymerized together into a common polymer, e.g., styrene and methyl methacrylate. Rather, the term “aromatic (meth)acrylate” refers to a single aromatic monomer that is functionalized by an acrylate, methacrylate, acrylic acid, or methacrylic acid, etc.

The weight average molecular weight (Mw, g/mol or Daltons) of the second acrylic binder can be from about 3,000 to about 30,000. As examples, the weight average molecular weight of the second acrylic binder may range from about 7,500 to about 9,000, may range from about 8,000 to about 9,000, may be about 8,000, or may be about 8,600. In another example, the second acrylic binder is a styrene acrylic binder having a weight average molecular weight ranging from about 3,000 to about 30,000.

The acid number of the second acrylic binder can be from about 120 mg KOH/g to about 300 mg KOH/g. As examples, the acid number of the second acrylic binder may range from about 150 mg KOH/g to about 230 mg KOH/g, may range from about 160 mg KOH/g to about 220 mg KOH/g, may range from about 165 mg KOH/g to about 215 mg KOH/g, may be about 165 mg KOH/g, or may be about 215 mg KOH/g. In another example, the second acrylic binder is a styrene acrylic binder having an acid number ranging from about 120 mg KOH/g to about 300 mg KOH/g.

The glass transition temperature (T_{g}) of the second acrylic binder can be from about 50° C. to about 100° C. As examples, the T_{g} of the second acrylic binder may range from about 70° C. to about 90° C., may range from about 75° C. to about 85° C., may be about 75° C., or may be about 85° C. In another example, the second acrylic binder is a styrene acrylic binder having a T_{g} ranging from about 50° C. to about 100° C.

The second acrylic binder can be in acid form, such as in the form of a polymer with (meth)acrylic acid surface groups, or may be in its salt form, such as in the form of a polymer with poly(meth)acrylate groups. The form (acid or salt) can be a function of pH. For example, if an acid were used during preparation of the polymer, pH modifications during preparation or subsequently when added to the ink composition can impact the nature of the moiety as well (acid form vs. salt form).

Any suitable styrene acrylate binder may be used. Some examples include those that are in the JONCRYL® family from BASF Corp., such as JONCRYL® 678 (weight average molecular weight of about 8,600, acid number of about 215 mg KOH/g, and T_{g} of about 85° C.), JONCRYL® 683 (weight average molecular weight of about 8,000, acid number of about 165 mg KOH/g, and T_{g} of about 75° C.), JONCRYL® 696 (weight average molecular weight of about 16,000, acid number of about 220 mg KOH/g, and T₉ of about 88° C.), etc. In one example, the second binder is JONCRYL® 678. In another example, the second binder is JONCRYL® 683.

In some examples of the lamination kit, the second binder is the second polyurethane binder. In some of these examples, the second polyurethane binder is a polyurethane binder. In some of these examples, the polyurethane has a weight average molecular weight ranging from about 40,000 to about 80,000, or from about 50,000 to about 80,000. In others of these examples, the polyurethane has an acid number ranging from about 20 mg KOH/g to about 40 mg KOH/g. The polyurethane binder may be a polyurethane dispersion including 20 wt % polyurethane.

In others of these examples, the second polyurethane binder is a polyurethane-acrylic hybrid binder. In some of these examples, the polyurethane-acrylic hybrid binder has a weight average molecular weight ranging from about 20,000 to about 40,000. In others of these examples, the polyurethane-acrylic hybrid binder has an acid number ranging from about 20 mg KOH/g to about 40 mg KOH/g. In still other examples, the polyurethane-acrylic hybrid binder has a weight average molecular weight of about 22,000 and/or an acid number of about 49 mg KOH/g.

As mentioned above, it may be desirable for the combination of the first binder (in the primer fluid) and the binder in the aqueous inkjet ink (referred to as “second binder”) to be compatible with lamination. As such, in some examples of the lamination kit, whether the second binder in the aqueous inkjet ink is the second acrylic binder or the second polyurethane binder may depend, at least in part, on the first binder that is included in the primer fluid. As an example, when the first binder in the primer fluid is the combination of the first acrylic binder and zirconium acetate, the second binder in the aqueous inkjet ink may be the second acrylic binder (e.g., JONCRYL® 678). As another example, when the first binder in the primer fluid is the combination of the first acrylic binder and the first polyurethane binder, the second binder in the aqueous inkjet ink may be the second polyurethane binder.

In some examples of the lamination kit, the second binder is present in the aqueous inkjet ink in an amount ranging from about 0.1 wt % active to about 6 wt % active, based on the total weight of the aqueous inkjet ink. In some examples, the second binder may be present in the aqueous inkjet ink in an amount ranging from about 1 wt % active to about 6 wt % active, from about 1 wt % active to about 3 wt % active, or from about 1 wt % active to about 2 wt % active, based on the total weight of the aqueous inkjet ink. As other examples, second binder may be present in the aqueous inkjet ink in an amount of about 1.8 wt % active, about 2 wt % active, about 2.8 wt % active, or about 5 wt % active.

The second binder (prior to being incorporated into the aqueous inkjet ink) may be dispersed in water alone or in combination with an additional water soluble or water miscible co-solvent, such as 2-pyrrolidone, 1-(2-hydroxyethyl)-2-pyrrolidone, 2-methyl-1,3-propanediol, 1,2-butanediol, diethylene glycol, or a combination thereof. It is to be understood however, that the liquid components of the dispersion become part of the aqueous liquid vehicle in the aqueous inkjet ink.

Pigments

The aqueous inkjet ink also includes a pigment. The pigment may be incorporated into the aqueous inkjet ink as a pigment dispersion. The pigment dispersion may include a pigment and a separate dispersant, or may include a self-dispersed pigment.

For the pigment dispersions disclosed herein, it is to be understood that the pigment and separate dispersant or the self-dispersed pigment (prior to being incorporated into the ink formulation), may be dispersed in water alone or in combination with an additional water soluble or water miscible co-solvent, such as those described for the second binder. It is to be understood however, that the liquid components of the pigment dispersion become part of the aqueous vehicle in the aqueous inkjet ink.

Whether separately dispersed or self-dispersed, the pigment can be any of a number of primary or secondary colors, or black or white. As specific examples, the pigment may be any color, including, as examples, a cyan pigment, a magenta pigment, a yellow pigment, a black pigment, a violet pigment, a green pigment, a brown pigment, an orange pigment, a purple pigment, a white pigment, or combinations thereof.

Pigments and Separate Dispersants

Examples of the aqueous inkjet ink may include a pigment that is not self-dispersing and a separate dispersant. Examples of these pigments, as well as suitable dispersants for these pigments will now be described.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50. Any quinacridone pigment or a co-crystal of quinacridone pigments may be used for magenta inks.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation, Boston, Mass., (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, C.I. Pigment Orange 71, and C.I. Pigment Orange 73.

The average particle size of the pigments may range anywhere from about 20 nm to about 200 nm. In an example, the average particle size ranges from about 80 nm to about 150 nm.

Any of the pigments mentioned herein can be dispersed by a separate dispersant, such as a styrene (meth)acrylate dispersant, or another dispersant suitable for keeping the pigment suspended in the aqueous ink vehicle. For example, the dispersant can be any dispersing (meth)acrylate polymer, or other type of polymer, such as maleic polymer or a dispersant with aromatic groups and a poly(ethylene oxide) chain. These separate dispersants may be milled dispersants.

In one example, (meth)acrylate polymer can be a styrene-acrylic type dispersant polymer, as it can promote π-stacking between the aromatic ring of the dispersant and various types of pigments, such as copper phthalocyanine pigments, for example. In one example, the styrene-acrylic dispersant can have a weight average molecular weight (M_{w}) ranging from about 4,000 to about 30,000. In another example, the styrene-acrylic dispersant can have a weight average molecular weight ranging from about 8,000 to about 28,000, from about 12,000 to about 25,000, from about 15,000 to about 25,000, from about 15,000 to about 20,000, or about 17,000. Regarding the acid number, the styrene-acrylic dispersant can have an acid number from 100 to 350, from 120 to 350, from 150 to 250, from 155 to 185, or about 172, for example. Example commercially available styrene-acrylic dispersants can include JONCRYL® 671, JONCRYL®71, JONCRYL®96, JONCRYL® 680, JONCRYL® 683, JONCRYL® 678, JONCRYL® 690, JONCRYL® 296, JONCRYL® 696 or JONCRYL® ECO 675 (all available from BASF Corp.).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. For examples, even if the monomer used to form the polymer was in the form of a (meth)acrylic acid during preparation, pH modifications during preparation or subsequently when added to an ink composition can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

The following are some example pigment and separate dispersant combinations: a carbon black pigment with a styrene acrylic dispersant; PB 15:3 (cyan pigment) with a styrene acrylic dispersant; PR122 (magenta) or a co-crystal of PR122 and PV19 (magenta) with a styrene acrylic dispersant; or PY74 (yellow) or PY155 (yellow) with a styrene acrylic dispersant.

In an example, the pigment is present in an amount ranging from about 1 wt % active to about 10 wt % active, based on the total weight of the aqueous inkjet ink. In other examples, the pigment is present in the aqueous inkjet ink in an amount ranging from about 1 wt % active to about 6 wt % active, from about 2 wt % active to about 6 wt % active, or from about 2 wt % active to about 4 wt % active, based on the total weight of the aqueous inkjet ink. When the separate dispersant is used, the separate dispersant may be present in an amount ranging from about 0.05 wt % active to about 6 wt % active of the total weight of the aqueous inkjet ink. In some examples, the ratio of pigment to separate dispersant may range from 0.5 (1:2) to 10 (10:1). In another example, the ratio of pigment to separate dispersant may be 3 (3:1).

Self-Dispersed Pigments

In other examples, the aqueous inkjet ink includes a self-dispersed pigment, which includes a pigment and an organic group attached thereto.

Any of the pigments set forth herein may be used, such as carbon, phthalocyanine, quinacridone, azo, or any other type of organic pigment, as long as at least one organic group that is capable of dispersing the pigment is attached to the pigment.

The organic group that is attached to the pigment includes at least one aromatic group, an alkyl (e.g., C₁ to C₂₀), and an ionic or ionizable group.

The aromatic group may be an unsaturated cyclic hydrocarbon containing one or more rings and may be substituted or unsubstituted, for example with alkyl groups. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like).

The alkyl may be branched or unbranched, substituted or unsubstituted.

The ionic or ionizable group may be at least one phosphorus-containing group, at least one sulfur-containing group, or at least one carboxylic acid group.

In an example, the at least one phosphorus-containing group has at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof. By “partial ester thereof”, it is meant that the phosphorus-containing group may be a partial phosphonic acid ester group having the formula —PO₃RH, or a salt thereof, wherein R is an aryl, alkaryl, aralkyl, or alkyl group. By “salts thereof”, it is meant that the phosphorus-containing group may be in a partially or fully ionized form having a cationic counterion.

When the organic group includes at least two phosphonic acid groups or salts thereof, either or both of the phosphonic acid groups may be a partial phosphonic ester group. Also, one of the phosphonic acid groups may be a phosphonic acid ester having the formula —PO₃R₂, while the other phosphonic acid group may be a partial phosphonic ester group, a phosphonic acid group, or a salt thereof. In some instances, it may be desirable that at least one of the phosphonic acid groups is either a phosphonic acid, a partial ester thereof, or salts thereof. When the organic group includes at least two phosphonic acid groups, either or both of the phosphonic acid groups may be in either a partially or fully ionized form. In these examples, either or both may of the phosphonic acid groups have the formula —PO₃H₂, —PO₃H⁻M⁺ (monobasic salt), or —PO₃⁻²M⁺² (dibasic salt), wherein M⁺ is a cation such as Na⁺, K⁺, Li⁺, or NR₄⁺, wherein R, which can be the same or different, represents hydrogen or an organic group such as a substituted or unsubstituted aryl and/or alkyl group.

As other examples, the organic group may include at least one geminal bisphosphonic acid group, partial esters thereof, or salts thereof. By “geminal”, it is meant that the at least two phosphonic acid groups, partial esters thereof, or salts thereof are directly bonded to the same carbon atom. Such a group may also be referred to as a 1,1-diphosphonic acid group, partial ester thereof, or salt thereof.

An example of a geminal bisphosphonic acid group may have the formula —CQ(PO₃H₂)₂, or may be partial esters thereof or salts thereof. Q is bonded to the geminal position and may be H, R, OR, SR, or NR₂ wherein R, which can be the same or different when multiple are present, is selected from H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. For examples, Q may be H, R, OR, SR, or NR₂, wherein R, which can be the same or different when multiple are present, is selected from H, a C₁-C₆ alkyl group, or an aryl group. As specific examples, Q is H, OH, or NH₂. Another example of a geminal bisphosphonic acid group may have the formula —(CH₂)ₙCQ(PO₃H₂)₂, or may be partial esters thereof or salts thereof, wherein Q is as described above and n is 0 to 9, such as 1 to 9. In some specific examples, n is 0 to 3, such as 1 to 3, or n is either 0 or 1.

Still another example of a geminal bisphosphonic acid group may have the formula —X—(CH₂)ₙCQ(PO₃H₂)₂, or may be partial esters thereof or salts thereof, wherein Q and n are as described above and X is an arylene, heteroarylene, alkylene, vinylidene, alkarylene, aralkylene, cyclic, or heterocyclic group. In specific examples, X is an arylene group, such as a phenylene, naphthalene, or biphenylene group, which may be further substituted with any group, such as one or more alkyl groups or aryl groups. When X is an alkylene group, examples include substituted or unsubstituted alkylene groups, which may be branched or unbranched and can be substituted with one or more groups, such as aromatic groups. Examples of X include C₁-C₁₂ groups like methylene, ethylene, propylene, or butylene. X may be directly attached to the pigment, meaning there are no additional atoms or groups from the attached organic group between the pigment and X. X may also be further substituted with one or more functional groups. Examples of functional groups include R′, OR′, COR′, COOR′, OCOR′, carboxylates, halogens, CN, NR′₂, SO₃H, sulfonates, sulfates, NR′(COR′), CONR′₂, imides, NO₂, phosphates, phosphonates, N═NR′, SOR′, NR′SO₂R′, and SO₂NR′₂, wherein R′, which can be the same or different when multiple are present, is independently selected from hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

Yet another example of a geminal bisphosphonic acid group may have the formula —X-Sp-(CH₂)ₙCQ(PO₃H₂)₂, or may be partial esters thereof or salt thereof, wherein X, Q, and n are as described above. “Sp” is a spacer group, which, as used herein, is a link between two groups. Sp can be a bond or a chemical group. Examples of chemical groups include, but are not limited to, —CO₂—, —O₂C—, —CO—, —OSO₂—, —SO₃—, —SO₂—, —SO₂C₂H₄O—, —SO₂C₂H₄S—, —SO₂C₂H₄NR″—, —O—, —S—, —NR″—, —NR″CO—, —CONR″—, —NR″CO₂—, —O₂CNR″—, —NR″CONR″—, —N(COR″)CO—, —CON(COR″)—, —NR″COCH(CH₂CO₂R″)— and cyclic imides therefrom, —NR″COCH₂CH(CO₂R″)— and cyclic imides therefrom, —CH(CH₂CO₂R″)CONR″— and cyclic imides therefrom, —CH(CO₂R″)CH₂CONR″ and cyclic imides therefrom (including phthalimide and maleimides of these), sulfonamide groups (including —SO₂NR″— and —NR″SO₂— groups), arylene groups, alkylene groups and the like. R″, which can be the same or different when multiple are included, represents H or an organic group such as a substituted or unsubstituted aryl or alkyl group. In the example formula —X-Sp-(CH₂)ₙCQ(PO₃H₂)₂, the two phosphonic acid groups or partial esters or salts thereof are bonded to X through the spacer group Sp. Sp may be —CO₂—, —O₂C—, —O—, —NR″—, —NR″CO—, or —CONR″—, —SO₂NR″—, —SO₂CH₂CH₂NR″—, —SO₂CH₂CH₂O—, or —SO₂CH₂CH₂S— wherein R″ is H or a C₁-C₆ alkyl group.

Still a further example of a geminal bisphosphonic acid group may have the formula —N—[(CH₂)ₘ(PO₃H₂)]₂, partial esters thereof, or salts thereof, wherein m, which can be the same or different, is 1 to 9. In specific examples, m is 1 to 3, or 1 or 2. As another example, the organic group may include at least one group having the formula —(CH₂)n-N—[(CH₂)ₘ(PO₃H₂)]₂, partial esters thereof, or salts thereof, wherein n is 0 to 9, such as 1 to 9, or 0 to 3, such as 1 to 3, and m is as defined above. Also, the organic group may include at least one group having the formula —X—(CH₂)n-N—[(CH₂)ₘ(PO₃H₂)]₂, partial esters thereof, or salts thereof, wherein X, m, and n are as described above, and, in an example, X is an arylene group. Still further, the organic group may include at least one group having the formula —X-Sp-(CH₂)n-N—[(CH₂)ₘ(PO₃H₂)]₂, partial esters thereof, or salts thereof, wherein X, m, n, and Sp are as described above.

Yet a further example of a geminal bisphosphonic acid group may have the formula —CR═C(PO₃H₂)₂, partial esters thereof, or salts thereof. In this example, R can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In an example, R is H, a C₁-C₆ alkyl group, or an aryl group.

The organic group may also include more than two phosphonic acid groups, partial esters thereof, or salts thereof, and may, for example include more than one type of group (such as two or more) in which each type of group includes at least two phosphonic acid groups, partial esters thereof, or salts thereof. For example, the organic group may include a group having the formula —X—[CQ(PO₃H₂)₂]ₚ, partial esters thereof, or salts thereof. In this example, X and Q are as described above. In this formula, p is 1 to 4, e.g., 2.

In addition, the organic group may include at least one vicinal bisphosphonic acid group, partial ester thereof, or salts thereof, meaning that these groups are adjacent to each other. Thus, the organic group may include two phosphonic acid groups, partial esters thereof, or salts thereof bonded to adjacent or neighboring carbon atoms. Such groups are also sometimes referred to as 1,2-diphosphonic acid groups, partial esters thereof, or salts thereof. The organic group including the two phosphonic acid groups, partial esters thereof, or salts thereof may be an aromatic group or an alkyl group, and therefore the vicinal bisphosphonic acid group may be a vicinal alkyl or a vicinal aryl diphosphonic acid group, partial ester thereof, or salts thereof. For example, the organic group may be a group having the formula —C₆H₃—(PO₃H₂)₂, partial esters thereof, or salts thereof, wherein the acid, ester, or salt groups are in positions ortho to each other.

In other examples, the ionic or ionizable group (of the organic group attached to the pigment) is a sulfur-containing group. The at least one sulfur-containing group has at least one S═O bond, such as a sulfinic acid group or a sulfonic acid group. Salts of sulfinic or sulfonic acids may also be used, such as —SO₃⁻ X, where X is a cation, such as Na⁺, H⁺, K⁺, NH₄⁺, Li⁺, Ca₂⁺, Mg⁺, etc.

When the ionic or ionizable group is a carboxylic acid group, the group may be COOH or a salt thereof, such as —COO⁻X⁺, —(COO⁻X⁺)₂, or —(COO⁻X⁺)₃.

Examples of the self-dispersed pigments are commercially available as dispersions. Suitable commercially available self-dispersed pigment dispersions include those of the CAB-O-JET® 200 Series, manufactured by Cabot Corporation. Some specific examples include CAB-O-JET® 200 (black pigment), CAB-O-JET® 250C (cyan pigment), CAB-O-JET® 260M or 265M (magenta pigment) and CAB-O-JET® 270 (yellow pigment)). Other suitable commercially available self-dispersed pigment dispersions include those of the CAB-O-JET® 400 Series, manufactured by Cabot Corporation. Some specific examples include CAB-O-JET® 400 (black pigment), CAB-O-JET® 450C (cyan pigment), CAB-O-JET® 465M (magenta pigment) and CAB-O-JET® 470Y (yellow pigment)). Still other suitable commercially available self-dispersed pigment dispersions include those of the CAB-O-JET® 300 Series, manufactured by Cabot Corporation. Some specific examples include CAB-O-JET® 300 (black pigment) and CAB-O-JET® 352K (black pigment).

The self-dispersed pigment may be present in an amount ranging from about 1 wt % active to about 10 wt % active, based on the total weight of the aqueous inkjet ink. In some examples, the self-dispersed pigment is present in the aqueous inkjet ink in an amount ranging from about 1 wt % active to about 6 wt % active, from about 2 wt % active to about 5 wt % active, or from about 2 wt % active to about 4 wt % active, based on the total weight of the aqueous inkjet ink.

Aqueous Ink Vehicles

As mentioned above, the aqueous inkjet ink includes a surfactant, a co-solvent, and a balance of water, in addition to the second binder and the pigment. The surfactant, co-solvent, and water may be part of an aqueous ink vehicle. As used herein, the term “aqueous ink vehicle” may refer to the liquid fluid in which the second binder and the pigment are mixed to form a thermal or a piezoelectric ink.

In an example of the aqueous inkjet ink, the aqueous ink vehicle includes a surfactant, a co-solvent, and a balance of water.

The surfactant(s) and the amounts thereof included in the aqueous inkjet ink may be selected so that the aqueous inkjet ink is able to wet a primed and pre-treated flexible film substrate.

The surfactant may include anionic and/or non-ionic surfactants. Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsulfonate, and dibutylphenylphenol disulfonate. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the liquid vehicle may include a silicone-free alkoxylated alcohol surfactant such as, for example, TEGO® Wet 510 (EvonikTegoChemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSN, ZONYL® FSO, ZONYL® FSH, and CAPSTONE® FS-35 (each of which is a water-soluble, ethoxylated non-ionic fluorosurfactant manufactured by E.I. DuPont de Nemours and Company); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.); and BYK® 345, BYK® 346, BYK® 347, BYK® 348, BYK® 349 (each of which is a silicone surfactant) (all of which are available from BYK Chemie).

Whether used alone or in combination, the total amount of the surfactant(s) that may be present in the aqueous inkjet ink may range from about 0.01 wt % active to about 5 wt % active, based on the total weight of the aqueous inkjet ink. In an example, the total amount of the surfactant(s) that may be present in the aqueous inkjet ink may range from about 0.05 wt % active to about 3 wt % active, based on the total weight of the aqueous inkjet ink. In another example, the total amount of the surfactant(s) that may be present in the aqueous inkjet ink may range from about 0.5 wt % active, based on the total weight of the aqueous inkjet ink.

The aqueous inkjet ink also includes a co-solvent. The co-solvent may be water soluble or water miscible and may improve decap and/or drying of the aqueous inkjet ink. As such, the co-solvent may be selected from the group consisting of a decap co-solvent (i.e., a co-solvent that may improve decap), a drying co-solvent (i.e., a co-solvent that may improve drying), and a combination thereof.

Examples of suitable decap and/or drying co-solvents include low-boiling point solvents. As mentioned above, low-boiling point solvents have a boiling point less than or equal to 250° C. In some examples of the fluid set, the co-solvent includes a low-boiling point solvent selected from the group consisting of 1,2-ethanediol; 1,2-propanediol; 1,3-propanediol; 2-methyl-1,3-propanediol; 1,2-butanediol; 1,3-butanediol; 1,4-butanediol; 1,5-pentanediol; 1,2-hexanediol; 2,5-hexanediol; 1,2-heptanediol; 1,2-octanediol; 1,8-octanediol; 2-pyrrolidone; 1-(2-hydroxyethyl)-2-pyrrolidone; diethylene glycol; tripropylene glycol methyl ether; and combinations thereof. In other examples, the low-boiling point solvent is tripropylene glycol methyl ether. In still other examples, the low-boiling point solvent has a boiling point less than 200° C. In one of these examples, the co-solvent is selected from the group consisting of 1,2-ethanediol; 1,2-propanediol; 2-methyl-1,3-propanediol; 1,2-butanediol; 1,8-octanediol; 1-(2-hydroxyethyl)-2-pyrrolidone; and combinations thereof. In another of these examples co-solvent is 1,2-butanediol.

In still other examples of the fluid set, the co-solvent includes a decap co-solvent and a drying co-solvent. Examples of the decap co-solvent include 1,2-ethanediol; 1,2-propanediol; 1,3-propanediol; 2-methyl-1,3-propanediol; 1,2-butanediol; 1,3-butanediol; 1,4-butanediol; 1,5-pentanediol; 1,2-hexanediol; 2,5-hexanediol; 1,2-heptanediol; 1,2-octanediol; and 1,8-octanediol. Examples of the drying co-solvent include 2-pyrrolidone; 1-(2-hydroxyethyl)-2-pyrrolidone; and tripropylene glycol methyl ether. In one of these examples, the decap co-solvent is 1,2-butanediol and the drying co-solvent is tripropylene glycol methyl ether (e.g., DOWANOL® TPM available from The Dow Chemical Co.).

Whether used alone or in combination, the total amount of the co-solvent(s) may be present in the aqueous inkjet ink in an amount ranging from about 4 wt % to about 30 wt %, based on the total weight of the aqueous inkjet ink. In some examples, the total amount of the co-solvent(s) may be present in the aqueous inkjet ink in an amount ranging from about 5 wt % active to about 25 wt % active, or from about 5 wt % active to about 10 wt % active, based on the total weight of the aqueous inkjet ink. In other examples, the total amount of the co-solvent(s) may be present in the aqueous inkjet ink in an amount of about 7 wt % active, or about 9 wt % active, based on the total weight of the aqueous inkjet ink.

It is to be understood that water is present in addition to the surfactant(s) and co-solvent(s). The water may be purified water or deionized water, and makes up a balance of the aqueous inkjet ink. As such, the weight percentage of the water present in the aqueous inkjet ink will depend, in part, upon the weight percentages of the other components. Further, it is to be understood that the water included in the aqueous inkjet ink may be: i) part of the second binder dispersion and/or the pigment dispersion, ii) part of the aqueous ink vehicle, iii) added to a mixture of the second binder dispersion and/or the pigment dispersion and the aqueous ink vehicle, or iv) a combination thereof.

An example of the aqueous inkjet ink further comprises an additive selected from the group consisting of a chelating agent, an antimicrobial agent, an anti-kogation agent, an anti-decel agent, a pH adjuster, and combination thereof.

Some examples of the aqueous inkjet ink include a chelating agent, an antimicrobial agent, and/or an anti-kogation agent. In these examples, aqueous inkjet ink may include any of the examples of the chelating agent, an antimicrobial agent, and/or an anti-kogation agent described above in reference to the aqueous vehicle of the fixer fluid. In these examples, aqueous inkjet ink may also include any of the amount of the chelating agent, an antimicrobial agent, and/or an anti-kogation agent described above in reference to the aqueous vehicle of the fixer fluid (with the amount(s) being based on the total weight of the aqueous inkjet ink rather than the total weight of the fixer fluid).

Anti-decel agents are another example of an additive that may be included in the aqueous inkjet ink. The anti-decel agent may function as a humectant. Decel refers to a decrease in drop velocity over time with continuous firing. In the examples disclosed herein, the anti-decel agent (s) is/are included to assist in preventing decel. In some examples, the anti-decel agent may improve the jettability of the aqueous inkjet ink. The anti-decel agent(s) may be present in an amount ranging from about 0.2 wt % active to about 5 wt % active (based on the total weight of the aqueous inkjet ink). In an example, the anti-decel agent is present in the aqueous inkjet ink in an amount of about 0.5 wt % active, based on the total weight of the aqueous inkjet ink.

An example of a suitable anti-decel agent is ethoxylated glycerin having the following formula:

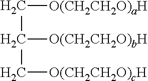

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

A pH adjuster may also be included in the aqueous inkjet ink. A pH adjuster may be included in the aqueous inkjet ink to achieve a desired pH (e.g., 8.5) and/or to counteract any slight pH drop that may occur over time. In an example, the total amount of pH adjuster(s) in the aqueous inkjet ink ranges from greater than 0 wt % to about 0.1 wt % (based on the total weight of the aqueous inkjet ink). In another example, the total amount of pH adjuster(s) in the aqueous inkjet ink about 0.03 wt % (based on the total weight of the aqueous inkjet ink).

Examples of suitable pH adjusters include metal hydroxide bases, such as potassium hydroxide (KOH), sodium hydroxide (NaOH), etc. In an example, the metal hydroxide base may be added to the inkjet ink in an aqueous solution. In another example, the metal hydroxide base may be added to the inkjet ink in an aqueous solution including 5 wt % of the metal hydroxide base (e.g., a 5 wt % potassium hydroxide aqueous solution).

Suitable pH ranges for examples of the aqueous inkjet ink can be from pH 7 to pH 11, from pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8. In one example, the pH of the aqueous inkjet ink is pH 8.5.

Lamination Adhesives

Examples of the lamination adhesive that may be used in the lamination kit may include a third binder. The lamination adhesive may be compatible with the primer fluid, the fixer fluid, and the aqueous inkjet ink disclosed herein. More specifically, the third binder in the lamination adhesive may be compatible with the first binder in the primer fluid and the second binder in the aqueous inkjet ink.

Examples of the lamination adhesive disclosed herein may be used in a drawdown coater, slot die coater, roller coater, fountain curtain coater, blade coater, rod coater, air knife coater, or gravure application to coat the printed flexible film substrate. The viscosity of the lamination adhesive may be adjusted for the type of coater or application that is to be used. As an example, the viscosity of the lamination adhesive may range from about 100 centipoise (cP) to about 300 cP (at 20° C. to 25° C. and about 100 rotations per minute (rpm)).

Third Binders

The third binder of the lamination adhesive may be a two-part polyurethane. As such, in some examples of the lamination kit, the lamination adhesive includes a two-part polyurethane. In these examples, the third binder includes a polyurethane binder and a crosslinker. In some examples, the crosslinker may be an epoxy crosslinker. In some of these examples, the lamination adhesive includes from about 1 wt % to about 5 wt % of the epoxy crosslinker. In one example, the lamination adhesive includes about 1 wt % of the epoxy crosslinker. An example of a commercially available polyurethane binder is PURETHANE™ A-1090 (water-based polyurethane available from Ashland Inc.). An example of a commercially available crosslinker for PURETHANE™ A-1090 is PURETHANE™ C-CAT-104 (water-based epoxy crosslinker including 90 wt % polyglycidyl ethers available from Ashland Inc.).

In some examples of the lamination kit, the third binder is present in the lamination adhesive in an amount ranging from about 30 wt % active to about 50 wt % active, based on the total weight of the lamination adhesive.

Additional Components

In some examples, the lamination adhesive includes water in addition to the third binder. The water may be added to the third binder or may be part of a dispersion of the third binder. In some examples, the lamination adhesive includes water in an amount ranging from about 50 wt % to about 70 wt %, based on the total weight of the lamination adhesive.

In some examples, the lamination adhesive consists of the third binder and water, with no other components. In other examples, the lamination adhesive may include additional components.

Lamination Methods

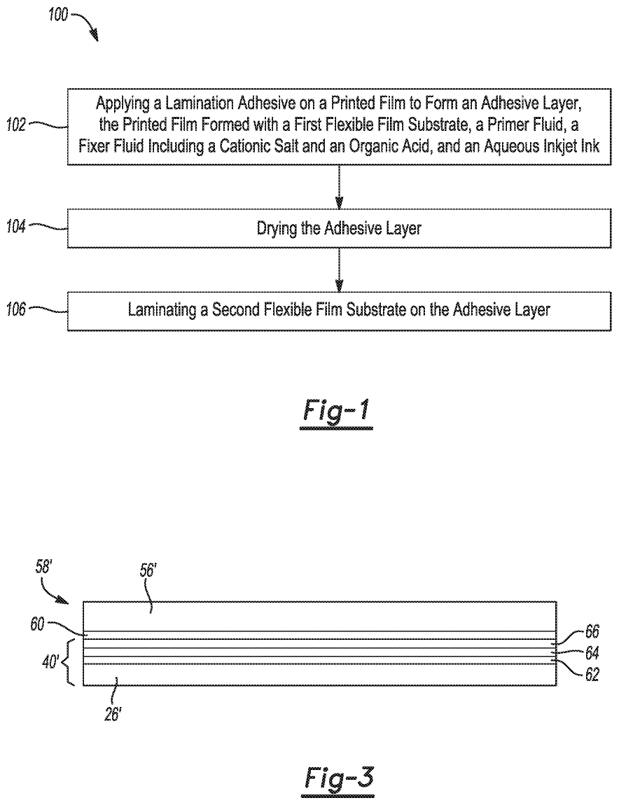

FIG. 1 depicts an example of the lamination method 100. The lamination method disclosed herein may be used to create flexible packaging.

As shown in FIG. 1, an example the lamination method 100 comprises: applying a lamination adhesive on a printed film to form an adhesive layer, the printed film formed with a first flexible film substrate, a primer fluid, a fixer fluid including a multivalent metal salt and an organic acid, and an aqueous inkjet ink (reference numeral 102); drying the adhesive layer (reference numeral 104); and laminating a second flexible film substrate on the adhesive layer (reference numeral 106).

It is to be understood that any example of the first flexible film substrate, the primer fluid, the fixer fluid, the aqueous inkjet ink, and/or the second flexible film substrate disclosed herein may be used in the examples of the method 100.

Forming the Printed Film

While not shown, the method 100 may include forming the printed film. In some of these examples, the method 100 further comprises, prior to the applying of the lamination adhesive, forming the printed film by: applying the primer fluid on the first flexible film substrate to form a primer layer, wherein the primer fluid includes a first binder, the first binder being a combination of a first acrylic binder and zirconium acetate or a combination of the first acrylic binder and a first polyurethane binder; drying the primer layer; inkjet printing the fixer fluid on the primer layer to form a fixer layer; inkjet printing the aqueous inkjet ink on the fixer layer to form an ink layer, the aqueous inkjet ink including: a second binder selected from the group consisting of a second acrylic binder, a second polyurethane binder, and a combination thereof; a pigment; a surfactant; a co-solvent; and a balance of water; and drying the ink layer.

In some examples, the method 100 may include subjecting the first flexible film substrate to a corona treatment or plasma treatment. When the first flexible film substrate is subjected to a corona treatment or plasma treatment, the corona treatment or plasma treatment may be applied before the primer fluid is applied.

In some examples, the method 100 includes applying the primer fluid on the first flexible film substrate to form a primer layer. In an example of the method 100, the primer is applied at a coat weight ranging from about 0.5 gsm to about 1.5 gsm. In another example, the primer fluid may be applied using a drawdown coater, slot die coater, roller coater, fountain curtain coater, blade coater, rod coater, air knife coater, or gravure application.

It is to be understood that the primer fluid is coated on all or substantially all of the first flexible film substrate. As such, the primer layer formed may be a continuous layer that covers all or substantially all of the first flexible film substrate.

After the primer fluid is applied on first flexible film substrate to form the primer layer, the method 100 may include drying the primer layer. In an example of the method 100, the drying of the primer layer is accomplished at a temperature ranging from about 90° C. to about 130° C. and for a time period ranging from about 5 minutes to about 20 minutes. In another example, the drying of the primer layer is accomplished at a temperature of about 120° C. In still another example, the drying of the primer layer is accomplished for a time period of about 10 minutes.

The method 100 may include inkjet printing the fixer fluid on the (dried) primer layer to form the fixer layer and inkjet printing the aqueous inkjet ink on the fixer layer to form the ink layer.

It is to be understood that the fixer fluid and the aqueous inkjet ink inkjet are printed at desirable areas. As such, the fixer layer that is formed by the application of the fixer fluid and/or the ink layer that is formed by the application of the aqueous inkjet ink may each be non-continuous. In other words, the fixer layer and/or the ink layer may contain gaps where no fixer fluid and/or ink is printed.

In some examples of the method 100, the fixer fluid and the aqueous inkjet ink may be applied in a single pass. As an example single pass printing, the cartridges of an inkjet printer respectively deposit each of the compositions during the same pass of the cartridges across the primed flexible film substrate. In other words, the fixer fluid and the aqueous inkjet ink are applied sequentially one immediately after the other as the applicators (e.g., cartridges, pens, printheads, etc.) pass over the primed flexible film substrate. In other examples, the fixer fluid and the aqueous inkjet ink may each be applied in separate passes.

In some examples of the method 100, the aqueous inkjet ink may be printed onto the fixer layer while the fixer layer is wet. Wet on wet printing may be desirable because less fixer fluid may be applied during this process (as compared to when the fixer layer is dried prior to ink application), and because the printing workflow may be simplified without the additional drying. In an example of wet on wet printing, the aqueous inkjet ink is printed onto the fixer layer within a period of time ranging from about 0.01 second to about 30 seconds after the fixer layer is printed. In further examples, the aqueous inkjet ink is printed onto the fixer layer within a period of time ranging from about 0.1 second to about 20 seconds; or from about 0.2 second to about 10 seconds; or from about 0.2 second to about 5 seconds after the fixer layer is printed. Wet on wet printing may be accomplished in a single pass.

In other examples of the method 100, the fixer layer is dried after the application of the fixer fluid and before the application of the aqueous inkjet ink. It is to be understood that in these examples, drying of the fixer layer may be accomplished in any suitable manner, e.g., air dried (e.g., at a temperature ranging from about 20° C. to about 80° C. for 30 seconds to 5 minutes), exposure to electromagnetic radiation (e.g. infra-red (IR) radiation for 5 seconds), and/or the like. When drying is performed, the compositions may be applied in separate passes to allow time for the drying to take place.

The fixer fluid and the aqueous inkjet ink may be inkjet printed using any suitable inkjet applicator, such as a thermal inkjet printhead, a piezoelectric printhead, a continuous inkjet printhead, etc. In some examples of the method 100, the inkjet printing of the fixer fluid and/or the inkjet printing of the aqueous inkjet ink may be accomplished at high printing speeds. In an example, the inkjet printing of the fixer fluid and/or the inkjet printing of the aqueous inkjet ink may be accomplished at a printing speed of at least 100 feet per minute (fpm). In another example, the fixer fluid and/or the aqueous inkjet ink may be inkjet printed a printing speed ranging from 100 fpm to 1000 fpm. In still another example, the fixer fluid and/or the aqueous inkjet ink may be inkjet printed a printing speed ranging from 400 fpm to 600 fpm.

In some examples, multiple aqueous inkjet inks may be inkjet printed onto the fixer layer to form the ink layer. In these examples, each of the aqueous inkjet inks may include an example of the second binder, a pigment, a surfactant, a co-solvent, and a balance of water. However, each of the aqueous inkjet inks may include a different pigment so that a different color (e.g., cyan, magenta, yellow, black, violet, green, brown, orange, purple, white, etc.) is generated by each of the aqueous inkjet inks. As an example, a combination of two or more aqueous inkjet inks selected from the group consisting of a cyan ink, a magenta ink, a yellow ink, and a black ink may be inkjet printed onto the fixer layer to form the ink layer.

In other examples, a single aqueous inkjet ink may be inkjet printed onto the fixer layer to form the ink layer.

In some examples, the method 100 further comprises drying the ink layer. It is to be understood that in these examples, drying of the ink layer may be accomplished in any suitable manner, e.g., air dried (e.g., at a temperature ranging from about 20° C. to about 80° C. for 30 seconds to 5 minutes), exposure to electromagnetic radiation (e.g. infra-red (IR) radiation for 5 seconds), and/or the like.

Laminating the Printed Film

As shown in reference numeral 102 in FIG. 1, the method 100 includes applying a lamination adhesive on a printed film to form an adhesive layer. In an example, the lamination adhesive is applied directly on the ink layer of the printed film. The lamination adhesive may be applied using a drawdown coater, slot die coater, roller coater, fountain curtain coater, blade coater, rod coater, air knife coater, or gravure application.

It is to be understood that the lamination adhesive is coated on all or substantially all of the printed film. As such, the adhesive layer that is formed may be a continuous layer that covers all or substantially all of the printed film. In other words, in some examples, the adhesive layer may be applied so that it covers the entire surface of the first flexible film substrate, which has the primer layer, the fixer fluid, and the ink layer applied thereon. When the adhesive layer coats substantially all of the printed film, it is meant that minor disruptions in the continuous layer may occur, for example, as a result of the coating process.

As shown in reference numeral 104 in FIG. 1, after the lamination adhesive is applied on the printed film to form the adhesive layer, the method 100 includes drying the adhesive layer. In an example of the method 100, the drying of the adhesive layer is accomplished at a temperature ranging from about 40° C. to about 70° C. and for a time period ranging from about 5 minutes to about 20 minutes. In another example, the drying of the adhesive layer is accomplished at a temperature of about 50° C. In still another example, the drying of the adhesive layer is accomplished for a time period of about 10 minutes.

In some examples, after the drying of the adhesive layer, the adhesive layer has a thickness ranging from about 1 μm to about 4 μm.

As shown in reference numeral 106 in FIG. 1, the method 100 includes laminating the second flexible film substrate on the adhesive layer. In some examples, the laminating of the second flexible film substrate on the adhesive layer may be accomplished with a laminator, such as hot roll laminator. In some specific examples of the method 100, the laminating is accomplished at a temperature ranging from about 43° C. to about 94° C. and a pressure ranging from about 50 psi to about 70 psi. In another example, the laminating is accomplished at a temperature of about 65.5° C. In still another example, the laminating is accomplished at a pressure of about 65 psi.

Laminating Systems

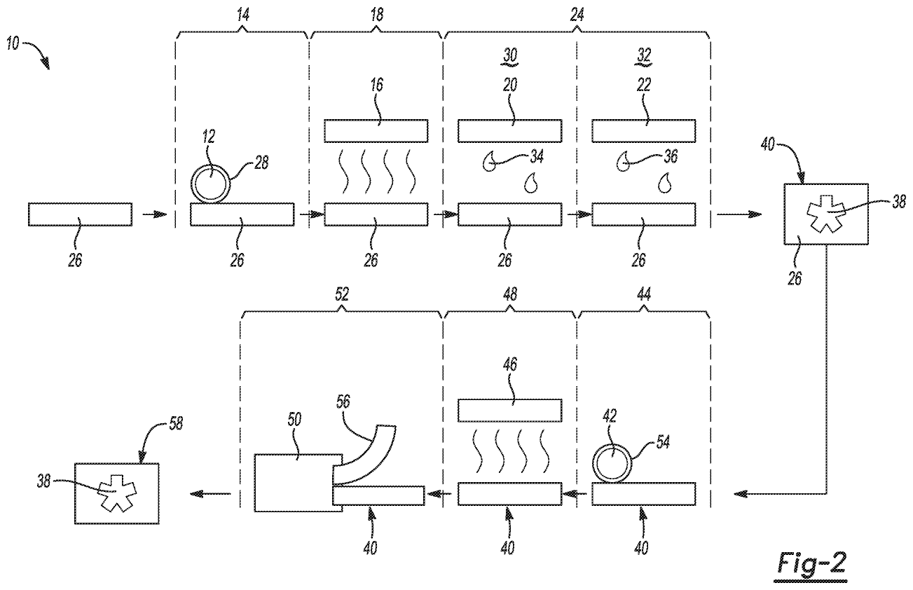

Referring now to FIG. 2, a schematic diagram of an example laminating system 10 is shown. In this example, the laminating system 10 includes a primer applicator 12 in a priming zone 14, a first dryer 16 in a first drying zone 18, inkjet printheads 20, 22 in a printing zone 24, an adhesive applicator 42 in an adhesive zone 44, a second dryer 46 in a second drying zone 48, and a laminator 50 in a lamination zone 52.

In one example, a first flexible film substrate 26 may be transported through the lamination system 10 along the path shown by the arrows, such that the first flexible film substrate 26 is first fed to the priming zone 14. In the priming zone 14, an example of the primer fluid 28 is applied directly onto the first flexible film substrate 26 by the primer applicator 12 (e.g., a drawdown coater, slot die coater, roller coater, fountain curtain coater, blade coater, rod coater, air knife coater, or gravure applicator) to form a primer layer on the first flexible film substrate 26.

The first flexible film substrate 26 (having the primer layer thereon) is then transported to the first drying zone 18 where the primer layer is heated to dry the primer layer. The heat is sufficient to evaporate all or substantially all of the liquid (e.g., water) from the primer layer. The heat to dry to the primer layer may range from about 90° C. to about 130° C.

The first flexible film substrate 26 (having the dried primer layer thereon) is then transported to the printing zone 24. In the printing zone 24, the first flexible film substrate 26 is first transported through a fixer zone 30 where an example of the fixer fluid 34 is inkjet printed directly onto the dried primer layer by the inkjet printhead 20 (for example, from a piezo- or thermal-inkjet printhead) to form a fixer layer on the dried primer layer. The fixer layer disposed on the dried primer layer may be heated in the printing zone 24 (for example, the air temperature in the printing zone 24 may range from about 10° C. to about 90° C.) such that the liquid (e.g., water) may be at least partially evaporated from the fixer layer. In this example, the first flexible film substrate 26 is then transported through an ink zone 32 where an example of the aqueous inkjet ink 36 is inkjet printed directly onto the fixer layer by the inkjet printhead 22 (for example, from a piezo- or thermal-inkjet printhead) to form an ink layer on the fixer layer. The ink layer may be heated in the printing zone 24 (for example, the air temperature in the printing zone 24 may range from about 10° C. to about 90° C.) such that the liquid (e.g., water) may be at least partially evaporated from the ink layer.

Rather than specific zones 30, 32 where each of the compositions 34, 36, is applied, it is to be understood that the laminating system 10 may include one printing zone 24 where inkjet cartridges are moved across the first flexible film substrate 26 to deposit the compositions 34, 36 in a single pass or in multiple passes. The applied fixer fluid 34 may or may not be dried prior to the application of the aqueous inkjet ink 36 in these examples.

The formation of the ink layer forms the printed film 40, which includes the image 38 formed on the first flexible film substrate 26.

The printed film 40 is then transported to the adhesive zone 44. In the adhesive zone 44, an example of the lamination adhesive 54 is applied directly onto the printed film 40 (over the ink layer) by the adhesive applicator 42 (e.g., a drawdown coater, slot die coater, roller coater, fountain curtain coater, blade coater, rod coater, air knife coater, or gravure applicator) to form an adhesive layer on the printed film 40.

The printed film 40 (having the adhesive layer thereon) is then transported to the second drying zone 48 where the adhesive layer is dried. In an example, the adhesive layer is heated in order to dry the adhesive layer. The heat is sufficient to evaporate all or substantially all of the liquid (e.g., water) from the adhesive layer. The heat applied to dry the adhesive layer may have a temperature ranging from about 40° C. to about 70° C.

The printed film 40 (having the dried adhesive layer thereon) is then transported to the lamination zone 52. In the lamination zone 52, the second flexible film substrate 56 is laminated directly on the dried adhesive layer by the laminator 50 (e.g., a Bertha laminator).

The lamination of the second flexible film substrate 56 on the adhesive layer forms the laminated article 58. The image 38 may be seen through the first flexible film substrate 26. In some examples, the laminated article 58 may be used for flexible packaging.

Laminated Articles

Referring now to FIG. 3, a schematic, cross-sectional view of an example of a laminated article 58′ is depicted. As mentioned above, the laminated article 58′ may be used as flexible packaging.

As shown in FIG. 3, an example of the laminated article 58′ comprises: a printed film 40′ formed with a first flexible film substrate 26′, a primer fluid, a fixer fluid including a cationic salt and an organic acid, and an aqueous inkjet ink; an adhesive layer 60 disposed on the printed film 40′; and a second flexible film substrate 56′ disposed on the adhesive layer 60. In some examples, the printed film 40′ of the laminated article 58′ includes: a first flexible film substrate 26′; a primer layer 62 disposed on the first flexible film substrate 26′; a fixer layer 64 disposed on the primer layer 62; and an ink layer 66 disposed on the fixer layer 64.

It is to be understood that any example of the first flexible film substrate 26′ and/or the second flexible film substrate 56′ disclosed herein may be used in the examples of the laminated article 58′. It is further to be understood that any example of the primer fluid disclosed herein may be used to form the primer layer 62, any example the fixer fluid disclosed herein may be used to form the fixer layer 64, and/or any example of the aqueous inkjet ink disclosed herein may be used to form the ink layer 66.

As mentioned above, the primer layer 62 may be a continuous layer that covers all or substantially all of the first flexible film substrate 26′. As also mentioned above, each of the fixer layer 64 and the ink layer 66 may be a non-continuous layer. More specifically, the primer layer 62 may coat the entire first flexible film substrate 26′, and the fixer layer 64 and ink layer 66 may be applied wherever it is desirable to form image(s). Further, the adhesive layer 60 may be a continuous layer that covers all or substantially all of the printed film 40′.

In some examples, an image defined by the ink layer 66 may be seen through the first flexible film substrate 56′.

In some examples, the laminated article 58′ has a lamination bond strength greater than 3.5 N/in. In other examples, the laminated article 58′ has a lamination bond strength greater than 4.0 N/in, greater than 4.5 N/in, greater than 5.0 N/in, greater than 5.5 N/in, greater than 6.0 N/in, or greater than 6.5 N/in. In other examples, the laminated article 58′ has a lamination bond strength ranging from about 4.0 N/in to about 7.0 N/in or from about 4.0 N/in to about 6.0 N/in.

In some examples, the laminated article 58′ also has a wet strength greater than 3.5 N/in. In other examples, the laminated article 58′ has a wet strength greater than 4.0 N/in, greater than 4.5 N/in, greater than 5.0 N/in, greater than 5.5 N/in, greater than 6.0 N/in, or greater than 6.5 N/in. In other examples, the laminated article 58′ has a wet strength ranging from about 4.0 N/in to about 7.0 N/in or from about 4.0 N/in to about 6.0 N/in. As used therein, the term “wet strength” may refer to the lamination bond strength of a laminated article 58′ after it has been soaking in hot water for a predetermined time period (e.g., after soaking in about 90° C. water for about 15 minutes).

To further illustrate the present disclosure, examples are given herein. It is to be understood that these examples are provided for illustrative purposes and are not to be construed as limiting the scope of the present disclosure.

### EXAMPLES

### Example 1

Two examples of the primer fluid were obtained (referred to as “Ex. Primer 1” and “Ex. Primer 2”). Ex. Primer 1 included about 70 wt % PRINTRITE™ DP282 (a water-based poly(ethyl acrylate) polymer dispersion available from Lubrizol) and about 30 wt % DIGIPRIME® 4431 (a water-based ethylene acrylic acid and polyurethane dispersion available from Michelman Inc.) as the first binder. Ex. Primer 1 also included ZONYL® FSN (a water-soluble, ethoxylated non-ionic fluorosurfactant manufactured by E.I. DuPont de Nemours and Company) as the fluorosurfactant. Ex. Primer 2 included AQUATACK™ 1422 (a water-based dispersion including 50 wt % active acrylic binder and 50 wt % active zirconium acetate available from Paramelt) as the first binder.

Several laminated articles were produced using the example primer fluids. First, prints were generated using the example primer fluids, an example fixer fluid, and example or comparative aqueous inkjet inks on biaxially oriented polypropylene (BOPP). For each print, the primer fluid was applied using a drawdown coater, and each of the primer layers formed was dried for 10 minutes at 120° C.

The example fixer fluid used included FLOQUAT® FL 2350 PWG (a cationic polyamine salt available from S.P.C.M. SA Company) as the cationic salt, and succinic acid as the organic acid. The general formulation of the example fixer fluid is shown in Table 1, with the wt % active of each component that was used.

TABLE 1

| | | Example fixer |
|---|---|---|
| | | fluid |
| Ingredient | Specific Component | (wt % active) |
| Cationic salt | FLOQUAT ® FL 2350 PWG | 2.45 |
| Organic acid | Succinic acid | 0.95 |
| Co-solvent | 1,2-butanediol | 20.0 |
| Wetting surfactant | CAPSTONE ® FS-35 | 0.41 |
| Dot gain surfactant | TERGITOL ® 15-S-7 | 0.95 |
| Water | Deionized water | Balance |

Each of the aqueous inkjet inks used included a black pigment dispersion including a separate styrene-acrylic dispersant (labeled “Black pigment dispersion” in Table 2) or a magenta pigment dispersion including a separate styrene-acrylic dispersant (labeled “Magenta pigment dispersion” in Table 2) as the pigment. The example aqueous inkjet inks that were used included 1.8 wt % active or 2.0 wt % active of JONCRYL® 678 (styrene acrylate binder having a weight average molecular weight of about 8,600, an acid number of about 215 mg KOH/g, and a T_{g} of about 85° C. available from BASF Corp.) or 2.0 wt % active or 2.8 wt % active of a polyurethane binder (labeled “PU” in Table 2) as the second binder. The comparative aqueous inkjet inks that were used did not include any binder. Each of the ink layers was formed on a wet fixer layer and then was dried with a dryer.

Then, laminated articles were generated using the prints, an example lamination adhesive, and treated polyethylene as the second substrate. The example lamination adhesive included PURETHANE™ A-1090 (water-based polyurethane available from Ashland Inc.) and 1 wt % PURETHANE™ C-CAT-104 (water-based epoxy crosslinker including 90 wt % polyglycidyl ethers available from Ashland Inc.). For each laminated article, the lamination adhesive was applied using a drawdown coater, and each of the adhesive layers formed was dried for 10 minutes at 50° C. The treated polyethylene was laminated on the adhesive layer using a hot roll laminator at about 65° C. and about 65 psi.

The lamination bond strength (LBS) of each of the laminated articles was tested using an Instron Tensile Tester. The Instron Tensile Tester measured the force (in Newton/inch (N/in)) that was sufficient to peel the treated polyethylene from the print (i.e., the lamination bond strength (LBS)).

The results of the lamination bond strength test of each laminated article are shown in Table 2. In Table 2, each laminated article is identified by the primer fluid and aqueous inkjet ink (indicated by the pigment and second binder included therein) used to produce the laminated article. In Table 2, any comparative ink is labeled (CE) in the column identifying the amount of second binder.

TABLE 2

| Primer fluid | Example and Comparative Aqueous inkjet ink used to generate the print | | | | |
|---|---|---|---|---|---|
| used to | Amount of | | Amount of | | |
| generate | second binder | Type of second | pigment | | LBS |
| the print | (wt % active) | binder | (wt % active) | Type of pigment | (N/in) |
| Ex. Primer 1 | 2.0 | PU | 2.5 | Black pigment dispersion | 5.3 |
| Ex. Primer 1 | 2.8 | PU | 4.0 | Magenta pigment dispersion | 7.0 |
| Ex. Primer 1 | 2.0 | JONCRYL ® 678 | 2.5 | Black pigment dispersion | 4.6 |
| Ex. Primer 1 | 1.8 | JONCRYL ® 678 | 4.0 | Magenta pigment dispersion | 5.4 |
| Ex. Primer 1 | 0 (CE) | None | 2.5 | Black pigment dispersion | 4.5 |
| Ex. Primer 1 | 0 (CE) | None | 4.0 | Magenta pigment dispersion | 3.4 |
| Ex. Primer 2 | 2.0 | JONCRYL ® 678 | 2.5 | Black pigment dispersion | 4.2 |
| Ex. Primer 2 | 1.8 | JONCRYL ® 678 | 4.0 | Magenta pigment dispersion | 4.0 |
| Ex. Primer 2 | 2.0 | PU | 2.5 | Black pigment dispersion | 3.5 |
| Ex. Primer 2 | 2.8 | PU | 4.0 | Magenta pigment dispersion | 4.0 |
| Ex. Primer 2 | 0 (CE) | None | 2.5 | Black pigment dispersion | 2.7 |
| Ex. Primer 2 | 0 (CE) | None | 4.0 | Magenta pigment dispersion | 2.6 |

As shown in Table 2, the laminated articles produced using an example primer fluid and an example aqueous inkjet ink had a lamination bond strength (LBS) of at least 3.5 N/in and as high as 7.0 N/in. The results shown in Table 2 indicate that Ex. Primer 1 and Ex. Primer 2 (in combination with the example fixer fluid, example aqueous inkjet inks, and the example lamination adhesive) are good primers for producing laminated articles.

As also shown in Table 2, laminated articles produced using Ex. Primer 1 and an aqueous inkjet ink including the polyurethane binder as the second binder had a lamination bond strength (LBS) higher than or comparable to the lamination bond strength (LBS) of any of the other laminated articles. Thus, the results shown in Table 2 further indicate that the combination of Ex. Primer 1 and an example aqueous inkjet ink including the polyurethane binder as the second binder is a good combination for producing laminated articles.

Further, Table 2 shows that the laminated articles produced using Ex. Primer 1 and an aqueous inkjet ink including JONCRYL® 678 as the second binder had a good lamination bond strength (LBS). Thus, the results shown in Table 2 also indicate that the combination of Ex. Primer 1 and an example aqueous inkjet ink including JONCRYL® 678 as the second binder is a good combination for producing laminated articles.

Table 2 also shows that the laminated articles produced using Ex. Primer 2 and an aqueous inkjet ink including JONCRYL® 678 as the second binder had a good lamination bond strength (LBS). Further, the laminated articles produced using Ex. Primer 2 and an aqueous inkjet ink including JONCRYL® 678 as the second binder had a lamination bond strength (LBS) higher than or comparable to the lamination bond strength (LBS) of any of the other laminated articles produced using Ex. Primer 2. Thus, the results shown in Table 2 also indicate that the combination of Ex. Primer 2 and an example aqueous inkjet ink including JONCRYL® 678 as the second binder is a good combination for producing laminated articles.

Further, Table 2 shows that the laminated articles produced using Ex. Primer 2 and an aqueous inkjet ink including the polyurethane binder as the second binder had a good lamination bond strength (LBS). Thus, the results shown in Table 2 also indicate that the combination of Ex. Primer 2 and an example aqueous inkjet ink including the polyurethane binder as the second binder is a good combination for producing laminated articles.

### Example 2

Seven additional examples of the aqueous inkjet ink disclosed herein (referred to as “Ex. Ink A,” “Ex. Ink B,” “Ex. Ink C,” “Ex. Ink F,” “Ex. Ink G,” “Ex. Ink H,” and “Ex. Ink I”) were prepared. These example aqueous inkjet inks included different amounts and types of the second binder. Some of these example aqueous inkjet inks included JONCRYL® 678 (having a weight average molecular weight of about 8,600, an acid number of about 215 mg KOH/g, and a T_{g} of about 85° C. available from BASF Corp.). Others of these example aqueous inkjet inks included a polyurethane binder having an acid number within the range of 20 to 40 and a weight average molecular weight within the range of 40,000 to 80,000 (labeled “PU” in Table 3).

Each of these example aqueous inkjet inks also included a black pigment dispersion including a separate styrene-acrylic dispersant (labeled “Black pigment dispersion” in Table 3), a magenta pigment dispersion including a separate styrene-acrylic dispersant (labeled “Magenta pigment dispersion” in Table 3), or a cyan pigment dispersion including a separate styrene-acrylic dispersant (labeled “Cyan pigment dispersion” in Table 3) as the pigment.

The general formulation of each of these example aqueous inkjet inks is shown in Table 3, with the wt % active of each component that was used.

TABLE 3

| | | Ex. | Ex. | Ex. | Ex. | Ex. | Ex. | Ex. |
|---|---|---|---|---|---|---|---|---|
| Ingredient | Specific Component | Ink A | Ink B | Ink C | Ink F | Ink G | Ink H | Ink I |
| Pigment | Black pigment dispersion | 2.5 | — | 2.5 | 2.5 | — | — | — |
| dispersion | Magenta pigment dispersion | — | 4.0 | — | — | 4.0 | 4.0 | — |
| | Cyan pigment dispersion | — | — | — | — | — | — | 2.0 |
| Binder | PU | 2.0 | 2.0 | 2.0 | — | — | 2.8 | — |
| | JONCRYL ® 678 | — | — | — | 2.0 | 2.0 | — | 2.0 |
| Decap co-solvent | 1,2-butanediol | 5.0 | 5.0 | 4.0 | 7.0 | 7.0 | 7.0 | 7.0 |
| Drying co-solvent | DOWANOL ® TPM | 2.0 | 2.0 | 3.0 | — | — | — | — |
| Surfactant | CAPSTONE ® FS-35 | 0.5 | 0.5 | 0.5 | 0.5 | 0.5 | 0.5 | 0.5 |
| Water | Deionized water | Bal. | Bal. | Bal. | Bal. | Bal. | Bal. | Bal. |

Two additional comparative aqueous inkjet inks (referred to as “Comp. Ink D” and “Comp. Ink E”) were also prepared. The comparative aqueous inkjet ink did not include any binder.

Each of the comparative aqueous inkjet inks also included a black pigment dispersion including a separate styrene-acrylic dispersant (labeled “Black pigment dispersion” in Table 4) or a magenta pigment dispersion including a separate styrene-acrylic dispersant (labeled “Magenta pigment dispersion” in Table 4) as the pigment.

The general formulation of each of these comparative aqueous inkjet inks is shown in Table 4, with the wt % active of each component that was used.

TABLE 4

| | | Comp. | Comp. |
|---|---|---|---|
| Ingredient | Specific Component | Ink D | Ink E |
| Pigment | Black pigment dispersion | 2.5 | — |
| dispersion | Magenta pigment dispersion | — | 4.0 |
| Decap co- | 1,2-butanediol | 7.0 | 7.0 |
| solvent | | | |
| Surfactant | CAPSTONE ® FS-35 | 0.5 | 0.5 |
| Water | Deionized water | Bal. | Bal. |

Several laminated articles were produced using the example primer fluids (from Example 1), the example fixer fluid (from Example 1), these additional aqueous inkjet inks, and the example lamination adhesive (from Example 1).

Prints were generated using the example primer fluids, the example fixer fluid, and either the example or comparative aqueous inkjet inks on biaxially oriented polypropylene (BOPP). For each print, the primer fluid was applied using a drawdown coater, and each of the primer layers formed was dried for 10 minutes at 120° C. Each of the printed ink layers was formed on a wet fixer layer and then was dried with a dryer.

Then, laminated articles were generated using the prints, the example lamination adhesive, and treated polyethylene. For each laminated article, the lamination adhesive was applied using a drawdown coater. The resulting adhesive layers were dried for 10 minutes at 50° C. The treated polyethylene was laminated on the adhesive layer using a hot roll laminator at about 65° C. and about 65 psi.

The lamination bond strength (LBS) of each of the laminated articles was tested using the Instron Tensile Tester.

The wet strength of some of the laminated articles was also tested. To test the wet strength, the laminated article was soaked in 90° C. water for 15 minutes, and then, the lamination bond strength (LBS) was tested using the Instron Tensile Tester.

The results of the lamination bond strength and wet strength tests of each of these laminated articles are shown in Table 5. In Table 5, each laminated article is identified by the primer fluid and aqueous inkjet ink used to produce the laminated article.

TABLE 5

| Primer fluid used to | Aqueous inkjet ink used | LBS | Wet strength |
|---|---|---|---|
| generate the print | to generate the print | (N/in) | (N/in) |
| Ex. Primer 1 | Ex. Ink A | 4.5 | 4.4 |
| Ex. Primer 1 | Ex. Ink B | 2.9 | 2.9 |
| Ex. Primer 1 | Ex. Ink C | 5.5 | 5.5 |
| Ex. Primer 1 | Comp. Ink D | 4.5 | Not tested |
| Ex. Primer 1 | Comp. Ink E | 3.4 | Not tested |
| Ex. Primer 1 | Ex. Ink F | 4.6 | Not tested |
| Ex. Primer 1 | Ex. Ink G | 5.4 | Not tested |
| Ex. Primer 1 | Ex. Ink H | 7.0 | Not tested |
| Ex. Primer 1 | Ex. Ink I | Not tested | Not tested |
| Ex. Primer 2 | Comp. Ink D | 2.7 | Not tested |
| Ex. Primer 2 | Comp. Ink E | 2.6 | Not tested |
| Ex. Primer 2 | Ex. Ink F | 4.2 | Not tested |
| Ex. Primer 2 | Ex. Ink G | 4.0 | Not tested |

As shown in Table 5, most of the laminated articles produced using an example primer fluid and an example aqueous inkjet ink had a lamination bond strength (LBS) of at least 3.5 N/in and as high as 7.0 N/in. Most of the laminated articles produced using an example primer fluid and an example aqueous inkjet ink (and that were tested) also had a wet strength of at least 3.5 N/in and as high as 5.5 N/in. Further, those laminated articles that were tested for wet strength had a wet strength that was comparable to its lamination bond strength. As such, it is believed that the wet strength of each of the other laminated articles (that were not tested for wet strength) would have been comparable to its lamination bond strength. Thus, the results shown in Table 5 indicate that the example primer fluids in combination with the example aqueous inkjet inks (and the example fixer fluid and the example lamination adhesive) are suitable for producing laminated articles with desirable bond strength.

The results shown in Table 5 also indicate that most of the laminated articles produced using an example primer fluid and a comparative aqueous inkjet ink (without a binder) had a lamination bond strength less than 3.5, which doesn't meet the standard for use in packaging.

The results shown in Table 5 further indicate that: the combination of Ex. Primer 1 and an example aqueous inkjet ink including the polyurethane binder as the second binder is a good combination for producing laminated articles; the combination of Ex. Primer 1 and an example aqueous inkjet ink including JONCRYL® 678 as the second binder is a good combination for producing laminated articles; the combination of Ex. Primer 2 and an example aqueous inkjet ink including JONCRYL® 678 as the second binder is a good combination for producing laminated articles; and the combination of Ex. Primer 2 and an example aqueous inkjet ink including the polyurethane binder as the second binder is a good combination for producing laminated articles.

It is to be understood that the ranges provided herein include the stated range and any value or sub-range within the stated range, as if such values or sub-ranges were explicitly recited. For example, from about 90° C. to about 130° C. should be interpreted to include not only the explicitly recited limits of from about 90° C. to about 130° C., but also to include individual values, such as about 95° C., about 106.7° C., about 110.79° C., about 123.97° C., etc., and sub-ranges, such as from about 91.13° C. to about 110° C., from about 100.25° C. to about 121° C., from about 113.1° C. to about 128.98° C., etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A lamination kit, comprising:
a first flexible film substrate;
a primer fluid including a first binder;
a fixer fluid, including:
a cationic salt; and
an organic acid;
an aqueous inkjet ink, including:
a second binder;
a pigment;
a surfactant;
a co-solvent; and
a balance of water;
a lamination adhesive; and
a second flexible film substrate.

2. The lamination kit as defined in claim 1 wherein the lamination adhesive includes a two-part polyurethane.

3. The lamination kit as defined in claim 1 wherein one or both of the first and second flexible film substrates comprise a material selected from the group consisting of polyethylenes, polyethylene terephthalate, polyvinyl chloride, polystyrenes, and biaxially oriented polypropylene.

4. The lamination kit as defined in claim 1 wherein the first binder is a combination of an acrylic binder and zirconium acetate.

5. The lamination kit as defined in claim 1 wherein the first binder is a combination of a poly(ethyl acrylate) binder and an ethylene acrylic acid and polyurethane binder.

6. The lamination kit as defined in claim 1 wherein the organic acid of the fixer fluid is selected from the group consisting of acetic acid, glycolic acid, malonic acid, malic acid, maleic acid, ascorbic acid, succinic acid, glutaric acid, fumaric acid, citric acid, tartaric acid, lactic acid, sulfonic acid, ortho-phosphoric acid, and combinations thereof.

7. The lamination kit as defined in claim 1 wherein the fixer fluid consists of:
the cationic salt;
the organic acid;
a surfactant;
a co-solvent; and
a balance of water.

8. A lamination method, comprising:
applying a lamination adhesive on a printed film to form an adhesive layer, the printed film formed with a first flexible film substrate, a primer fluid, a fixer fluid including a cationic salt and an organic acid, and an aqueous inkjet ink;
drying the adhesive layer; and
laminating a second flexible film substrate on the adhesive layer.

9. The lamination method as defined in claim 8 wherein the laminating is accomplished at a temperature ranging from about 43° C. to about 93° C. and a pressure ranging from about 50 psi to about 70 psi.

10. The lamination method as defined in claim 8 wherein the drying of the adhesive layer is accomplished at a temperature ranging from about 40° C. to about 70° C. and for a time period ranging from about 5 minutes to about 20 minutes.

11. The lamination method as defined in claim 8 wherein, after the drying the adhesive layer, the adhesive layer has a thickness ranging from about 1 μm to about 4 μm.

12. The lamination method as defined in claim 8, further comprising, prior to the applying of the lamination adhesive, forming the printed film by:
applying the primer fluid on the first flexible film substrate to form a primer layer, wherein the primer fluid includes a first binder, the first binder being a combination of a first acrylic binder and zirconium acetate, or a combination of the first acrylic binder and a first polyurethane binder;
drying the primer layer;
inkjet printing the fixer fluid on the primer layer to form a fixer layer;
inkjet printing the aqueous inkjet ink on the fixer layer to form an ink layer, the aqueous inkjet ink including:
a second binder selected from the group consisting of a second acrylic binder, a second polyurethane binder, and a combination thereof;
a pigment;
a surfactant;
a co-solvent; and
a balance of water; and
drying the ink layer.

13. A laminated article, comprising:
a printed film formed with a first flexible film substrate, a primer fluid, a fixer fluid including a cationic salt and an organic acid, and an aqueous inkjet ink;
an adhesive layer disposed on the printed film; and
a second flexible film substrate disposed on the adhesive layer.

14. The laminated article as defined in claim 13 wherein the laminated article has a lamination bond strength greater than 3.5 N/in.
